(19) United States
(12) Patent Application Publication
(10) Pub. No.: US 2026/0221369 A1
(43) Pub. Date: Jul. 30, 2026

(54) FUSE ELEMENT AND PROTECTION ELEMENT

(71) Applicant: DEXERIALS CORPORATION, Shimotsuke-shi, Tochigi (JP)

(72) Inventor: Yoshihiro YONEDA, Shimotsuke-shi, Tochigi (JP)

(73) Assignee: DEXERIALS CORPORATION, Shimotsuke-shi, Tochigi (JP)

(21) Appl. No.: 19/147,003

(22) PCT Filed: Dec. 1, 2023
(86) PCT No.: PCT/JP2023/043137

§ 371 Date: Jul. 10, 2025

(30) Foreign Application Priority Data
Jan. 20, 2023 (JP) 2023-007368
Jun. 8, 2023 (JP) 2023-094988

(51) Int. Cl. H01H 85/143; H01H 85/00; H01H 85/042; H01H 85/11; H01H 85/12; H01H 85/38

(52) U.S. Cl. CPC H01H 85/143; H01H 85/0047; H01H 85/042; H01H 85/11; H01H 85/12; H01H 2085/388

(57) ABSTRACT

A fuse element includes: a first element made of silver or copper, or an alloy comprising silver or copper as a main component thereof; a second element made of silver or copper, or an alloy comprising silver or copper as a main component thereof; and a connecting metal composed of tin or an alloy comprising tin as a main component thereof, connecting an end of the first element to an end of the second element.

### TECHNICAL FIELD

The present invention relates to a fuse element and a protection element. The present invention claims priority based on JP 2023-007368 filed in Japan on Jan. 20, 2023 and JP 2023-094988 filed in Japan on Jun. 8, 2023, the contents of which are incorporated herein by reference.

### BACKGROUND ART

Conventionally, there is a fuse element that generates heat and blows to interrupt a current path when a current exceeding a rated value flows through the current path. Protective devices equipped with protection elements (fuse elements) are used in a wide range of applications, from home appliances to electric vehicles, and the like.

For example, lithium-ion batteries are used in a wide range of applications, such as mobile devices to electric vehicles (EVs) and storage batteries, and their capacity is increasing. As the capacity of lithium-ion batteries increases, the voltage has become higher, at several hundred volts, and the current has also become higher, at several hundred to several thousand amperes. Furthermore, current fuses up to now for high voltage and large current (100 V/100 A or more) only interrupt overcurrent, and none have the ability to interrupt in response to an interrupt signal.

Other prior art includes forming holes, notches, or the like in a foil fuse element, or utilizing thickness changes to create heat spots, thereby causing the fuse element to blow in the event of an overcurrent. For example, there is the following prior art.

For example, Patent Document 1 discloses a fuse in which, in a conductive thin film pattern formed on an insulating substrate, a thickness of an interrupting portion is set thinner than a thickness of a connecting portion.

For example, Patent Documents 2 and 3 disclose forming a blowing portion by punching holes in a plurality of elements arranged in parallel in a fuse element.

For example, Patent Documents 4 and 5 disclose fuse links in which, in an insulating substrate and a conductive thin film pattern formed on a surface of the insulating substrate, a thickness of an interrupting portion is set thinner than a thickness of a connecting portion.

For example, Patent Document 6 discloses a circuit protection element in which fuse elements are disposed in parallel on an insulating substrate, and a blowing portion is formed by a trimming groove.

An example of a circuit interruption using an interrupt signal is a pyro-fuse (current breaker).

### PRIOR ART DOCUMENTS

### Patent Documents

Patent Document 1: JP 6057413
Patent Document 2: JP 6199368
Patent Document 3: JP 5952751
Patent Document 4: JP 5116119
Patent Document 5: JP 4998890
Patent Document 6: JP 6754941

### SUMMARY OF INVENTION

### Problem to be Solved by Invention

In a protection element installed in a current path of a high voltage and a large current, when a fuse element blows, an arc discharge is likely to occur. When a large arc occurs, an insulating case that houses the fuse element may be destroyed. For this reason, metals with low resistance and high melting point, such as copper, are used as materials for fuse elements to suppress the occurrence of arc discharge.

However, with copper foil elements, when attempting to interrupt a relatively small overcurrent, such as 1.5 times the rated current, the interruption time may be long. In addition, the melting point of copper foil is high, at approximately 1085° C. For this reason, when the insulating case is composed of plastic, which has a melting point of approximately 300° C., there is a high possibility that the case will melt and be destroyed.

Furthermore, when a silver-plated tin alloy is used as the material for the fuse element, the amount of melted material that splashes onto the fuse may increase when a high-voltage, large-current circuit is interrupted. In this case, there is a high possibility that the scale of the arc discharge will increase and the insulation resistance will decrease.

Furthermore, in a spring-operated fuse system, when the fuse element is too hard, a large spring stress is required to cut the fuse.

The present invention has been configured in consideration of the above circumstances, and one object thereof is to provide a fuse element that blows at a low temperature of about 300° C., has a small molten volume, and is easy to cut. Another object of the present invention is to provide a protection element that achieves both overcurrent blocking and active blocking.

### Means for Solving Problem

In order to solve the above problems, the present invention provides the following means.
[1] A fuse element, having a first element made of silver or copper, or an alloy primarily composed of silver or copper, a second element made of silver or copper, or an alloy primarily composed of silver or copper, and a connecting metal composed of tin or an alloy primarily composed of tin, connecting an end of the first element to an end of the second element.
[2] The fuse element according to [1], wherein heat generated by an overcurrent flowing through the fuse element melts the connecting metal, and the molten material of the connecting metal melts the end of the first element, thereby blowing at least the first element.
[3] The fuse element according to [1] or [2], wherein a thickness of the first element is thinner than a thickness of the second element.
[4] The fuse element according to [3], wherein the thickness of the first element is half or less of the thickness of the second element.
[5] A protection element, having: a first terminal; a second terminal; and a fuse element connected to a current path connecting the first terminal and the second terminal, the fuse element having a first element made of silver or copper, or an alloy mainly composed of silver or copper, a second element made of silver or copper, or an alloy mainly composed of silver or copper, and connected in series to the first element on the current path, and a connecting metal composed of tin or an alloy mainly composed of tin, connecting an end of the first element and an end of the second element.
[6] The protection element according to [5], wherein heat generated by an overcurrent flowing through the fuse element melts the connecting metal, and the molten material of the connecting metal melts the end of the first element, thereby blowing at least the first element.
[7] The protection element according to [5] or [6], wherein a thickness of the first element is thinner than a thickness of the second element.
[8] The protection element according to [7], wherein the thickness of the first element is half or less of the thickness of the second element.
[9] The protection element according to any of [5] to [8], further having a heating element, wherein the heating element generates heat to melt the connecting metal, and the molten material of the connecting metal melts the end of the first element, thereby blowing at least the first element.
[10] The protection element according to any of [5] to [9], wherein the protection element has a plurality of the fuse elements, and a plurality of the fuse elements are connected in parallel between the first terminal and the second terminal.
[11] A protection element, having: a first terminal; a second terminal; and a fuse element connected to a current path connecting the first terminal and the second terminal, the fuse element having a first element made of silver or copper, or an alloy mainly composed of silver or copper, a second element made of silver or copper, or an alloy mainly composed of silver or copper, and connected in series to the first element on the current path, a third element made of silver or copper, or an alloy mainly composed of silver or copper, and connected in series with the first element on the current path, a connecting metal composed of tin or an alloy mainly composed of tin, connecting one end of the first element and one end of the second element, and a connecting metal connecting another end of the first element and one end of the third element.
[12] The protection element according to [11], wherein heat generated by an overcurrent flowing in the fuse element melts the connecting metal, and the molten material of the connecting metal melts one or the other end of the first element, thereby blowing at least the first element.
[13] The protection element according to [11] or [12], wherein a thickness of the first element is thinner than each of a thickness of the second element and a thickness of the third element.
[14] The protection element according to [13], wherein a thickness of the first element is half or less of each of a thickness of the second element and a thickness of the third element.
[15] The protection element according to [11] or [14], further having a heating element, wherein the heating element generates heat to melt the connecting metal, and the molten material of the connecting metal melts the one end or the other end of the first element, thereby blowing at least the first element.
[16] The protection element according to any of [11] to [15], wherein the protection element has a plurality of the fuse elements, and a plurality of the fuse elements are connected in parallel between the first terminal and the second terminal.

### Effect of Invention

According to the present invention, it is possible to provide a fuse element that melts at a low temperature of about 300° C., has a small molten volume, and is easy to cut. It is also possible to provide a protection element that achieves both overcurrent blocking and active blocking.

### BRIEF DESCRIPTION OF DRAWINGS

FIG. 1 A perspective view illustrating the appearance and cross-section of a protection element according to a first embodiment.

FIG. 2 An exploded perspective view of the protection element according to the first embodiment.

FIG. 3 An exploded perspective view illustrating a portion of the protection element illustrated in FIG. 2.

FIG. 4 An enlarged cross-sectional view illustrating the vicinity of portion IV in FIG. 1.

FIG. 5 An enlarged cross-sectional view of the portion V in FIG. 4.

FIG. 6A A perspective view illustrating a heating element.

FIG. 6B A top view illustrating one example of a heating element.

FIG. 6C A top view illustrating another example of a heating element.

FIG. 7 A cross-sectional view corresponding to FIG. 5, illustrating a state in which a portion of the fuse element is blown due to heat generated by a heating element in response to an interrupt signal.

FIG. 8 A cross-sectional view corresponding to FIG. 5, illustrating a state in which a portion of the fuse element is blown (gone) due to an overcurrent.

FIG. 9A A schematic diagram illustrating one example of a fuse element.

FIG. 9B A schematic diagram illustrating a state in which a portion of the fuse element illustrated in FIG. 9A is blown.

FIG. 10A A schematic diagram illustrating another example of a fuse element.

FIG. 10B A schematic diagram illustrating a state in which a portion of the fuse element illustrated in FIG. 10A is blown.

FIG. 11 A cross-sectional view (cross-sectional view perpendicular to the width direction) illustrating a protection element according to a second embodiment.

FIG. 12 A cross-sectional view corresponding to FIG. 11, illustrating a state in which a shielding member has cut off the fuse element and been lowered to its lowest position.

FIG. 13 A cross-sectional view (cross-sectional view perpendicular to the width direction) schematically illustrating a portion of the protection element according to the second embodiment.

FIG. 14 A cross-sectional view corresponding to FIG. 13, illustrating a state in which the shielding member has been moved downward.

FIG. 15 A cross-sectional view (cross-sectional view perpendicular to the width direction) schematically illustrating a portion of the protection element according to a modification of the second embodiment.

FIG. 16 A cross-sectional view corresponding to FIG. 15, illustrating a state in which the shielding member has been moved downward.

FIG. 17 A cross-sectional view (cross-sectional view perpendicular to the width direction) schematically illustrating a portion of the protection element according to another modification of the second embodiment.

FIG. 18 A perspective view of a heating element as viewed from one side.

FIG. 19 A perspective view of a heating element as viewed from another side.

FIG. 20 A perspective view illustrating a state in which a current path in a heating element is interrupted.

FIG. 21 A perspective view for describing one example of a current path in a heating element.

FIG. 22 A cross-sectional view (cross-sectional view perpendicular to the width direction) illustrating a portion of the protection element in another modification of the second embodiment.

### EMBODIMENTS OF INVENTION

A protection element to which the present art is applied will be described in detail below while referencing the drawings as appropriate. The drawings used in the description below may illustrate characteristic portions in an enlarged scale for the sake of convenience in order to make the characteristics easier to understand, and the dimensional ratios and the like of each constituent element may differ from reality. The materials, dimensions, and the like exemplified in the description below are one example, the present invention is not limited thereto, and such can be modified as appropriate within the scope of the effects of the present invention.

### Protection Element (First Embodiment)

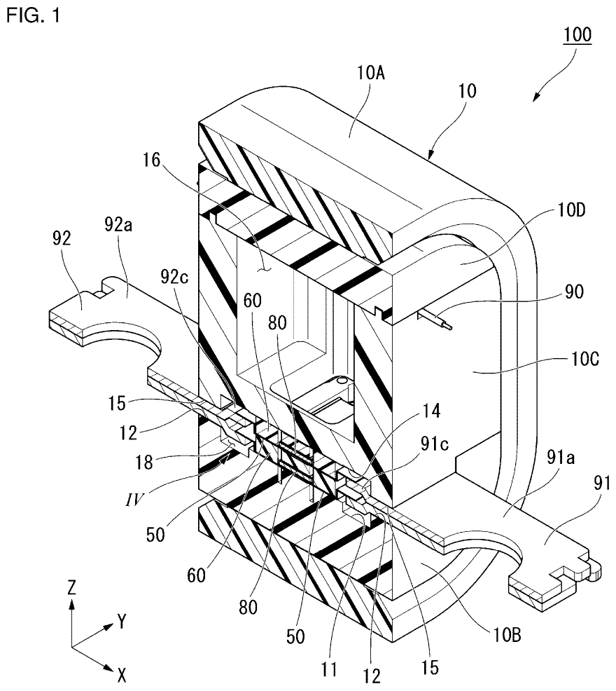

A protection element 100 according to one embodiment of the present invention will be described with reference to FIGS. 1 to 10B. The protection element 100 of the present embodiment is an electric component that constitutes a portion of a high-voltage, high-current (100 V/100 A or more) electric circuit that uses, for example, a lithium-ion battery. The protection element 100 is mounted on, for example, an electric vehicle (EV) or the like.

As illustrated in FIG. 1 to FIG. 3, the protection element 100 is provided with a first terminal 91 and a second terminal 92 disposed apart from each other in a predetermined direction, a fusible fuse element 50 disposed between the first terminal 91 and the second terminal 92 and electrically connecting them, an insulating member 60 disposed facing a thickness of the first element is thinner than both a thickness of the second element and a thickness of the third element. the fuse element 50, a heating element 80 disposed overlapping the fuse element 50, a power supply member 90 that passes current through the heating element 80, and an insulating case 10 that accommodates a portion of the first terminal 91, a portion of the second terminal 92, the fuse element 50, the insulating member 60, the heating element 80, and a portion of the power supply member 90. The first terminal 91 and the second terminal 92 each have a plate shape.

The protection element 100 of the present embodiment has, as a mechanism for interrupting the current path, an overcurrent interruption in which the fuse element 50 blows and interrupts the current path when an overcurrent (a current equal to or greater than a specified value) exceeding a rated current flows through the fuse element 50, and an active interruption in which, when an abnormality other than an overcurrent occurs, a current is passed through the heating element 80, causing it to generate heat, thereby blowing the fuse element 50 and interrupting the current path.

### (Direction Definition)

In the present embodiment, an XYZ orthogonal coordinate system (three-dimensional orthogonal coordinate system) is set as appropriate in each drawing, and each configuration will be described.

The foregoing predetermined direction in which the first terminal 91 and the second terminal 92 are provided is referred to as the front-rear direction. The front-rear direction corresponds to the X-axis direction in each drawing. In the X-axis direction, the direction from the first terminal 91 to the second terminal 92 (−X side) is called the front side, and the direction from the second terminal 92 to the first terminal 91 (+X side) is called the rear side.

The front-rear direction is a direction connecting the first terminal 91 and the second terminal 92, and is also the direction in which electricity flows when the protection element 100 is in use, and therefore may be rephrased as the current flow direction.

The direction in which respective plate surfaces of the first terminal 91 and the second terminal 92 face is referred to as the vertical direction. The vertical direction is a direction orthogonal to the front-rear direction, and corresponds to the Z-axis direction in each drawing. In the vertical direction, the upper side corresponds to the +Z side and the lower side corresponds to the −Z side.

The direction orthogonal to the front-rear direction and the vertical direction is called the left-right direction. The left-right direction corresponds to the Y-axis direction in each drawing. In the left-right direction, the left side corresponds to the −Y side, and the right side corresponds to the +Y side. Specifically, the −Y side is the left side when the protection element 100 is viewed from the rear (+X side), and the +Y side is the right side when the protection element 100 is viewed from the rear. The left-right direction may also be referred to as the width direction. In this case, for example, one side in the width direction corresponds to the −Y side, and the other side in the width direction corresponds to the +Y side.

Note that in the present embodiment, the terms front side, rear side, upper side, lower side, left side, and right side are convenient names for easily explaining the relative positional relationships of each component, and the actual positional relationships, and the like need not be those indicated by these names.

### (Insulating Case)

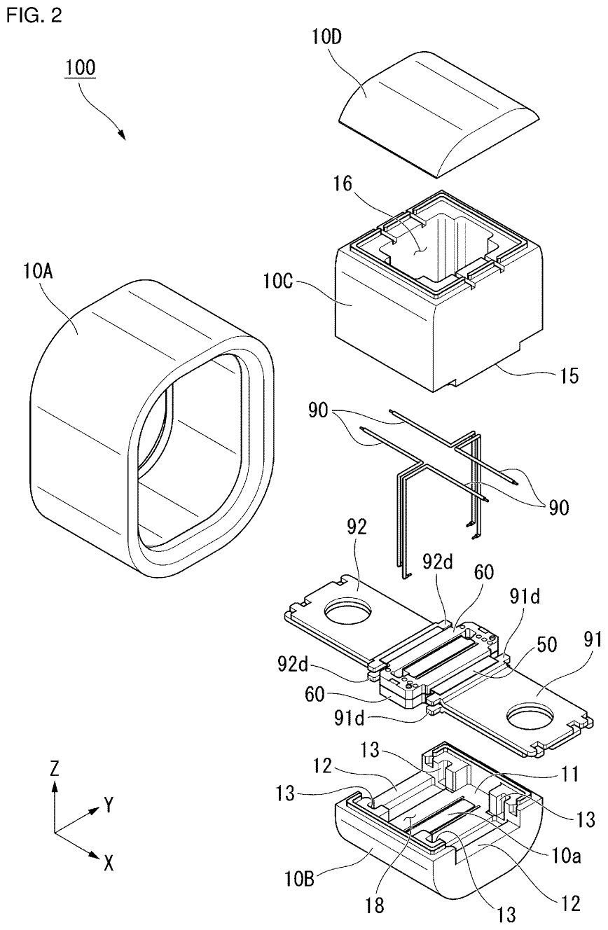

As illustrated in FIG. 1, the insulating case 10 has an overall shape of a column extending in the front-rear direction. As illustrated in FIG. 1 and FIG. 2, the insulating case 10 has at least two (three in the present embodiment) holding members 10B, 10C, and 10D stacked in the vertical direction, and a cylindrical cover 10A that houses these holding members 10B, 10C, and 10D. At least two holding members 10B and 10C are disposed on both sides of the fuse element 50 in the vertical direction.

The multiple holding members 10B, 10C, and 10D include a first holding member 10B, a second holding member 10C, and a third holding member 10D.

The first holding member 10B is located at the lowermost side among the three holding members 10B, 10C, and 10D. The first holding member 10B is disposed below the first terminal 91, the second terminal 92, and the fuse element 50. The first holding member 10B has a substantially cylindrical shape with a bottom that opens upward.

The first holding member 10B has a first housing portion 11, a terminal mounting surface 12, and a terminal locking portion 13.

The first housing portion 11 is recessed downward from the upper surface of the first holding member 10B. The first housing portion 11 is disposed in a middle portion of the first holding member 10B located between both ends in the front-rear direction. The first housing portion 11 has a substantially rectangular hole shape that opens upward.

The terminal mounting surface 12 is recessed downward from the upper surface of the first holding member 10B. The bottom surface of the terminal mounting surface 12 is flat and faces upward, and extends in a plane direction perpendicular to the vertical direction (X-Y plane direction). A pair of terminal mounting surfaces 12 are provided on the first holding member 10B. The pair of terminal mounting surfaces 12 are disposed at both ends of the first holding member 10B in the front-rear direction.

A terminal locking portion 13 is disposed on side walls provided at ends of the first holding member 10B in the left-right direction. The terminal locking portion 13 is a groove extending in the vertical direction, and opens on the upper surface of the first holding member 10B and on a wall surface facing inward (toward the center) in the left-right direction of the side wall. The terminal locking portions 13 are provided in pairs on the front and rear portions of the first holding member 10B (that is, four in total). The pair of terminal locking portions 13 are disposed facing each other with a gap therebetween in the left-right direction.

The second holding member 10C is located in the center in the vertical direction among the three holding members 10B, 10C, and 10D. The second holding member 10C is located above the first terminal 91, the second terminal 92 and the fuse element 50. The second holding member 10C has a cylindrical shape that extends in the vertical direction. Specifically, the second holding member 10C has a substantially rectangular tubular shape that is open on the upper and lower sides.

The second holding member 10C has a second housing portion 14 and a terminal pressing surface 15.

The second housing portion 14 is concave, recessed upward from the bottom surface of the second holding member 10C. The second housing portion 14 is located in the middle portion of the second holding member 10C between the two ends in the front-rear direction. The second housing portion 14 is a substantially rectangular hole opening downward.

The terminal pressing surface 15 is convex and protrudes downward from the lower surface of second holding member 10C. The lower-facing end surface of the terminal pressing surface 15 is flat and extends in the plane direction perpendicular to the vertical direction (X-Y plane direction). A pair of terminal pressing surfaces 15 is provided on the second holding member 10C. The pair of terminal pressing surfaces 15 is located at both ends of the second holding member 10C in the front-rear direction.

The third holding member 10D is the uppermost of the three holding members 10B, 10C, and 10D. The third holding member 10D is plate-shaped, extending in a plane perpendicular to the vertical direction.

The cover 10A is tubular and extends in the front-rear direction. Specifically, the cover 10A has a substantially rectangular tubular shape that is open on the front side and rear side. The three holding members 10B, 10C, and 10D are housed within the cover 10A in a combined state side by side vertically. The cover 10A holds at least two (three in the present embodiment) holding members 10B, 10C, and 10D in a fixed state by adhesive or the like.

When the first holding member 10B and the second holding member 10C are combined, the first housing portion 11 and the second housing portion 14 face each other to form one chamber (space) 18. In this chamber 18, a portion (front end) of the first terminal 91, a portion (rear end) of the second terminal 92, the fuse element 50, the insulating member 60, and the heating element 80 are disposed. That is, a portion of the first terminal 91 (front end), a portion of the second terminal 92 (rear end), fuse element 50, insulating member 60, and heating element 80 are placed between the two holding members 10B, 10C.

Furthermore, the insulating case 10 has an internal pressure buffer space 16 formed inside the insulating case 10. The internal pressure buffer space 16 is disposed inside the second holding member 10C. The internal pressure buffering space 16 is a substantially rectangular parallelepiped space, and communicates with the chamber (space) 18. In the present embodiment, the vertical dimension of the internal pressure buffer space 16 is, for example, ⅓ or more and ½ or less, based on the vertical dimension (external height) of the entire protection element 100. The internal pressure buffer space 16 has the effect of suppressing a sudden increase in the internal pressure of the protection element 100 caused by gas generated by an arc discharge that occurs when the fuse element 50 blows.

The cover 10A and each of the holding members 10B to 10D are preferably formed from a material having a tracking resistance index CTI (resistance to tracking (carbonized conductive path) breakdown) of 500 V or more. The tracking resistance index CTI can be determined by a test based on IEC60112.

The material of the cover 10A and each of the holding members 10B to 10D may be a resin material.

Resin materials have smaller heat capacities and lower melting points than ceramic materials. For this reason, using a resin material as the material for the holding members 10B to 10D is preferable because it has the property of weakening the arc discharge caused by gasification cooling (ablation), and when the molten and scattered metal particles adhere to the holding members 10B to 10D, the surface of the holding members 10B to 10D deforms or the adhesions aggregate, making the metal particles sparse and making it difficult to form a conductive path.

For example, a polyamide resin or a fluorine resin may be used as the resin material. The polyamide resin may be an aliphatic polyamide or a semi-aromatic polyamide. Examples of aliphatic polyamides include nylon 4, nylon 6, nylon 46, and nylon 66. Examples of semi-aromatic polyamides include nylon 6T, nylon 9T, and polyphthalamide (PPA) resins. An example of the fluorine resin is polytetrafluoroethylene. Furthermore, polyamide resins and fluorine resins have high heat resistance and are difficult to burn. In particular, aliphatic polyamides are less likely to produce graphite when burned. Therefore, by forming the cover 10A and each of the holding members 10B to 10D using an aliphatic polyamide, it is possible to more reliably prevent the formation of a new current path due to graphite generated by arc discharge when the fuse element 50 blows.

### (First Terminal, Second Terminal)

The first terminal 91 and the second terminal 92 each have a plate shape extending in a plane direction (X-Y plane direction) perpendicular to the vertical direction, and specifically, have a substantially rectangular plate shape. The first terminal 91 and the second terminal 92 are disposed apart from each other in the front-rear direction.

As illustrated in FIG. 1, the front end of the first terminal 91 is connected to the rear end of the fuse element 50. A rear portion of the first terminal 91 protrudes rearward from the insulating case 10 and is exposed to the outside of the insulating case 10. The rear end of the second terminal 92 is connected to the front end of the fuse element 50. The front portion of the second terminal 92 protrudes forward from the insulating case 10 and is exposed to the outside of the insulating case 10.

The first terminal 91 and the second terminal 92 may have substantially the same shape as each other, or may have different shapes from each other. The thickness dimension (vertical dimension) of the first terminal 91 and the second terminal 92 is not particularly limited, but is, for example, several hundred m to several mm, or the like. The thickness dimension of the first terminal 91 and the thickness dimension of the second terminal 92 may be the same as each other or may be different from each other.

As illustrated in FIG. 1 to FIG. 4, the first terminal 91 has a terminal body 91a, an external terminal hole 91b, a conductor connecting portion 91c, and a locking claw 91d.

The terminal body 91a is in the form of a rectangular plate that is long in the front-rear direction. The terminal body 91a is sandwiched between the terminal mounting surface 12 of the first holding member 10B and the terminal pressing surface 15 of the second holding member 10C.

The external terminal hole 91b is a circular hole that passes through the terminal body 91a in the vertical direction.

The conductor connecting portion 91c is disposed at the front end of the first terminal 91 and extends in the left-right direction. The conductor connecting portion 91c is disposed in a chamber (space) 18 defined by the first housing portion 11 and the second housing portion 14. The conductor connecting portion 91c has a larger vertical dimension than the terminal body 91a. In other words, the vertical dimension of the conductor connecting portion 91c is greater than the vertical dimension between the terminal mounting surface 12 and the terminal pressing surface 15.

The rear end of the fuse element 50 is connected to the conductor connecting portion 91c by soldering or the like. The conductor connecting portion 91c has a pair of connection plates 91e disposed at an interval from each other in the vertical direction. In the present embodiment, a plurality of fuse elements 50 is provided, and the rear end of each fuse element 50 is connected to each connection plate 91e.

The locking claw 91d is disposed at the front end of the first terminal 91, and protrudes in the left-right direction beyond the terminal body 91a. Specifically, the locking claw 91d is provided to protrude from both the left end and right end of the conductor connecting portion 91c. When the first terminal 91 is attached to the first holding member 10B, the locking claw 91d is inserted into the terminal locking portion 13. When the locking claw 91d and the terminal locking portion 13 are locked, the first terminal 91 is positioned in the front-rear direction with respect to the first holding member 10B, and movement in the front-rear direction is restricted.

The second terminal 92 has a terminal body 92a, an external terminal hole 92b, a conductor connecting portion 92c, and a locking claw 92d.

The terminal body 92a is in the form of a rectangular plate that is long in the front-rear direction. The terminal body 92a is sandwiched between the terminal mounting surface 12 of the first holding member 10B and the terminal pressing surface 15 of the second holding member 10C.

The external terminal hole 92b is a circular hole that penetrates the terminal body 92a in the vertical direction.

The conductor connecting portion 92c is disposed at the rear end of the second terminal 92 and extends in the left-right direction. The conductor connecting portion 92c is disposed in a chamber (space) 18 defined by the first housing portion 11 and the second housing portion 14. The conductor connecting portion 92c has a larger vertical dimension than the terminal body 92a. In other words, the vertical dimension of the conductor connecting portion 92c is greater than the vertical dimension between the terminal mounting surface 12 and the terminal pressing surface 15.

The front end of the fuse element 50 is connected to the conductor connecting portion 92c by soldering or the like. The conductor connecting portion 92c has a pair of connection plates 92e disposed at an interval from each other in the vertical direction. In the present embodiment, a plurality of fuse elements 50 is provided, and the front end of each fuse element 50 is connected to each connection plate 92e.

The locking claw 92d is disposed at the rear end of the second terminal 92, and protrudes in the left-right direction beyond the terminal body 92a. Specifically, the locking claw 92d is provided to protrude from both the left end and right end of the conductor connecting portion 92c. When the second terminal 92 is attached to the first holding member 10B, the locking claw 92d is inserted into the terminal locking portion 13. When the locking claw 92d and the terminal locking portion 13 are locked, the second terminal 92 is positioned in the front-rear direction with respect to the first holding member 10B, and movement in the front-rear direction is restricted.

Of the pair of external terminal holes 91b and 92b, one is used for connection to the power supply side, and the other is used for connection to the load side. Alternatively, the external terminal holes 91b and 92b may be used for connection to an internal current path of a load.

The first terminal 91 and the second terminal 92 are composed of a metal such as copper, brass, or nickel. As the material for the first terminal 91 and the second terminal 92, brass is preferably used from the viewpoint of increasing rigidity, and copper is preferably used from the viewpoint of reducing electrical resistance. The first terminal 91 and the second terminal 92 may be composed of the same material or different materials.

### (Fuse Element)

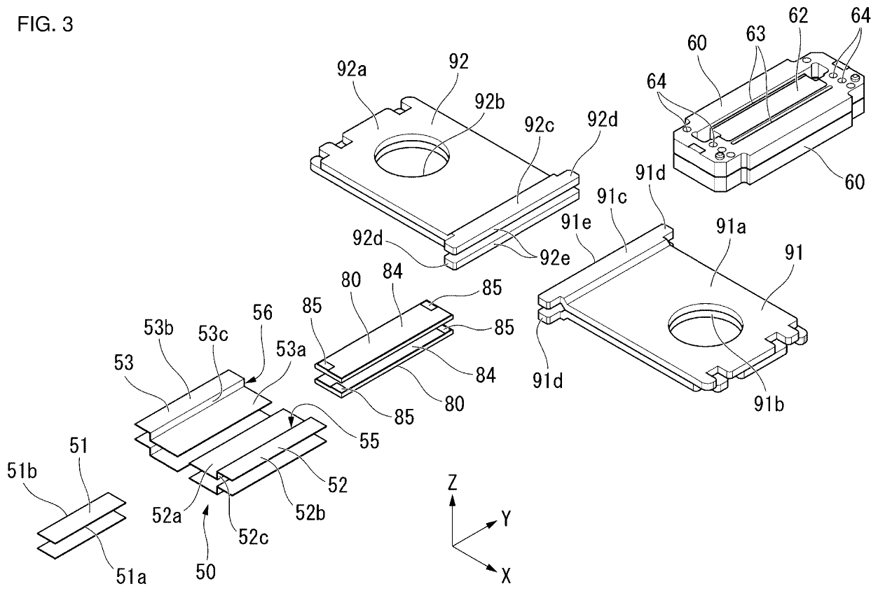

As illustrated in FIG. 3 to FIG. 5, the fuse element 50 is composed of a metal plate member, a sheet member, a metal foil, or the like. In the present embodiment, a plurality of fuse elements is provided, and the plurality of fuse elements is connected in parallel between the first terminal 91 and the second terminal 92. In the present embodiment, two fuse elements 50 are provided side by side in the vertical direction. However, the present invention is not limited thereto, and one fuse element 50 may be provided alone, or three or more may be provided side by side in the vertical direction.

The fuse element 50 has a first element 51, a second element 52 and a third element 53 connected in series with the first element 51 on a current path, a connecting metal 86 connecting a first end 51a (one end) of the first element 51 to one end of the second element 52, and a connecting metal 86 connecting a second end 51b (the other end) of the first element 51 to one end of the third element 53. The other end of the second element 52 or the other end of the third element 53 is connected to the first terminal 91 or the second terminal 92.

The first element 51 is composed of the same material as the second element 52 and the third element 53 or a material having a lower melting temperature than each of the second element 52 and the third element 53. In this embodiment, the first element 51 may have a lower electrical resistivity than each of the second element 52 and the third element 53, or may be the same.

In the present embodiment, the first element 51 functions as a fuse portion of the fuse element 50 during both an overcurrent interruption and an active interruption.

The first element 51 is plate-shaped, sheet-shaped, or foil-shaped and extends in a plane direction (X-Y plane direction) perpendicular to the vertical direction. As illustrated in FIG. 3, in the present embodiment, the first element 51 has a rectangular plate shape in which the left-right dimension is larger than the front-rear dimension when viewed in the vertical direction. The first element 51 is disposed, for example, in the center of the fuse element 50 in the front-rear direction.

However, the first element 51 may have a punched hole shape or may be disposed in parallel with multiple elements.

The first element 51 is composed of silver or copper, or an alloy containing silver or copper as a main component. The first element 51 may contain Ag or Cu, and may be Ag alone, Cu alone, an Ag alloy, or a Cu alloy. The Ag alloy has the highest Ag content among the metals contained in the alloy, and the Cu alloy has the highest Cu content among the metals contained in the alloy. That is, the first element 51 may be composed of Ag or Cu, or may be composed mainly of Ag or Cu.

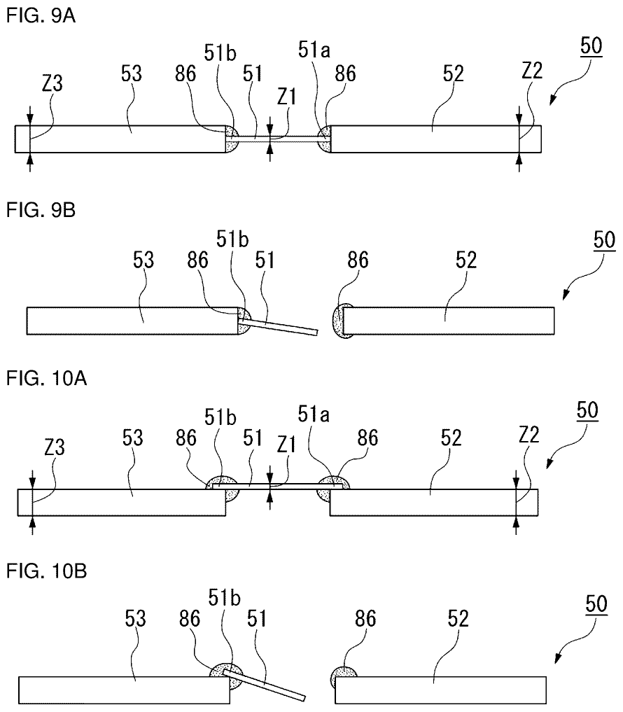

Tn the present embodiment, the thickness Z1 of the first element 51 is smaller than each of the thickness Z2 of the second element 52 and the thickness Z3 of the third element 53 (see FIG. 9A and FIG. 10A). In the present embodiment, a thickness Z1 of the first element 51 is half or less of each of a thickness Z2 of the second element 52 and a thickness Z3 of the third element 53. In the present embodiment, the thickness Z1 of the first element 51 is about ¼ of each of the thickness Z2 of the second element 52 and the thickness Z3 of the third element 53. For example, the thickness Z1 of the first element 51 may be set to a thickness of not less than 10 μm and not more than 30 μm.

Each of the second element 52 and the third element 53 is plate-shaped, sheet-shaped, or foil-shaped. As illustrated in FIG. 3, each of the second element 52 and the third element 53 in the present embodiment has a substantially rectangular plate shape with a left-right dimension longer than the front-rear dimension when viewed from the vertical direction. The fuse element 50 includes a plurality of second elements 52 and a plurality of third elements 53. The second element 52 and the third element 53 are disposed, for example, at both ends of the fuse element 50 in the front-rear direction.

As illustrated in FIG. 3 to FIG. 5, the present embodiment includes a second element 52 connecting the first terminal 91 and the first end (rear end) 51a of the first element 51, and a third element 53 connecting the second terminal 92 and the second end (front end) 51b of the first element 51. That is, in the present embodiment, each fuse element 50 has a pair of a second element 52 and a third element 53.

In the present embodiment, the second element 52, the first element 51, and the third element 53 are connected in series in this order to form a current path for the fuse element 50. The second element 52 and the third element 53 are connected to both ends 51a and 51b of the first element 51 in the current flow direction of the fuse element 50 (which corresponds to approximately the front-rear direction in the present embodiment).

For example, as illustrated in FIG. 9A, the first end 51a of a first element 51 may be fixed to the vertical center portion of a front end surface of a second element 52. In other words, the rear end surface of the first end 51a of the first element 51 and the front end surface of the second element 52 may be connected to each other.

In addition, the second end 51b of the first element 51 may be fixed to the vertical center of the rear end surface of the third element 53. In other words, the front end surface of the second end 51b of the first element 51 and the rear end surface of the third element 53 may be connected.

The first element 51 may be disposed between the end surfaces of the second element 52 and the third element 53 and may span therebetween.

Furthermore, for example, the first end 51a of the first element 51 may be fixed over the front end of the second element 52, as illustrated in FIG. 10A. In other words, the lower surface of the first end 51a of the first element 51 and the upper surface of the front end of the second element 52 may be connected.

The second end 51b of the first element 51 may be fixed over the rear end of the third element 53. In other words, the lower surface of the second end 51b of the first element 51 and the upper surface of the rear end of the third element 53 may be connected.

The first element 51 may be positioned above each of the second and third elements 52 and 53 and hung between them.

In the present embodiment, heat generated by an overcurrent flowing through the fuse element 50 causes the connecting metal 86 to melt, and the molten material of the connecting metal 86 melts one end 51a or the other end 51b of the first element 51, thereby blowing at least the first element 51 (see FIG. 9B and FIG. 10B). In the example in the drawing, the molten material of the connecting metal 86 melts one end 51a of the first element 51, causing a portion of the first element 51 to blow.

Furthermore, the present embodiment has a heating element 80, and when the heating element 80 generates heat, the connecting metal 86 melts, and the molten material of the connecting metal 86 melts one end 51a or the other end 51b of the first element 51, thereby blowing at least the first element 51 (see FIG. 9B and FIG. 10B). In the example in the drawing, the molten material of the connecting metal 86 melts one end 51a of the first element 51, causing a portion of the first element 51 to blow.

The second element 52 and the third element 53 are composed of silver or copper, or alloys mainly composed of silver or copper. The second element 52 and the third element 53 may contain Ag or Cu, and may be Ag alone, Cu alone, an Ag alloy, or a Cu alloy. The Ag alloy has the highest Ag content among the metals contained in the alloy, and the Cu alloy has the highest Cu content among the metals contained in the alloy. That is, second element 52 and the third element 53 may be composed of Ag or Cu, or may be composed mainly of Ag or Cu.

The connecting metal 86 is composed of tin or an alloy containing tin as a main component. The connecting metal 86 may contain Sn, and may be Sn alone or a Sn alloy. Sn alloys are alloys whose main component is Sn. That is, the connecting metal 86 may be composed of Sn or a material containing Sn as a main component. Sn alloys are the alloys with the highest Sn content among all the metals contained in alloys. Examples of Sn alloys include Sn—Bi alloys, In—Sn alloys, Sn—Ag—Cu alloys, and the like.

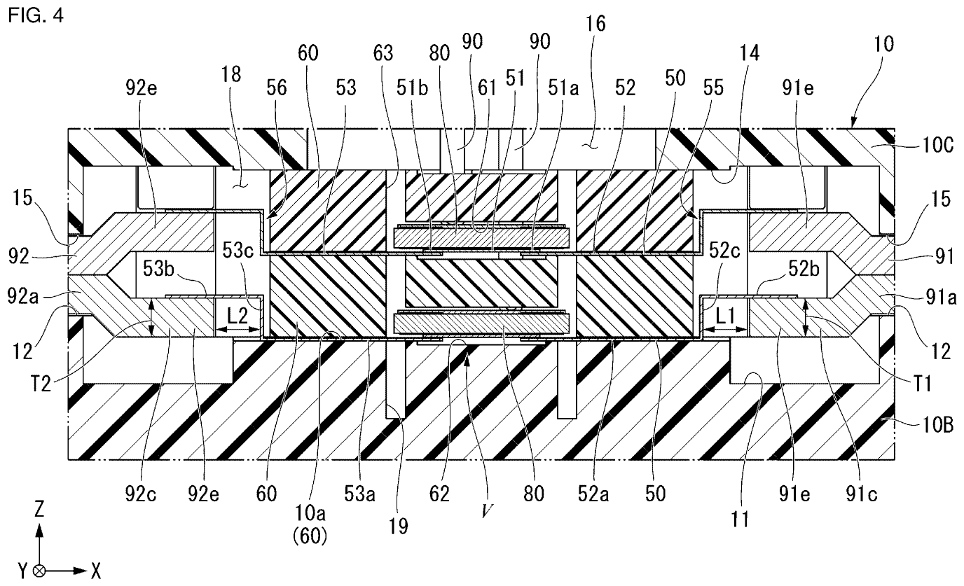

As illustrated in FIG. 3 and FIG. 4, the fuse element 50 further has a first bent portion 55 and a second bent portion 56.

The first bent portion 55 is disposed between the first terminal 91 and a portion of the fuse element 50 that faces the insulating member 60. In other words, the first bent portion 55 is disposed between the insulating member 60 and the first terminal 91 in the front-rear direction. Specifically, the first bent portion 55 is provided in the second element 52.

Specifically, the second element 52 has an inner plate portion 52a connected to the first element 51, an outer plate portion 52b connected to the first terminal 91, and a connecting plate portion 52c connecting the inner plate portion 52a and the outer plate portion 52b.

The inner plate portion 52a is plate-shaped, extending in a plane direction (X-Y plane direction) perpendicular to the vertical direction. The front end of the inner plate portion 52a is connected to the first end 51a of the first element 51 using a connecting metal 86 by soldering or the like.

The outer plate portion 52b is plate-shaped, extending in the plane direction perpendicular to the vertical direction (X-Y plane direction). The outer plate portion 52b is disposed rearward and above the inner plate portion 52a. A rear portion of the outer plate portion 52b is connected to a connection plate 91e of the conductor connecting portion 91c by soldering or the like.

The connecting plate portion 52c is plate-shaped, extending in a plane direction (Y-Z plane direction) perpendicular to the front-rear direction. The connecting plate portion 52c may extend in a plane direction inclined relative to the Y-Z plane. That is, in a cross-sectional view perpendicular to the left-right direction (Y-axis direction) as illustrated in FIG. 4, the connecting plate portion 52c may extend along the vertical direction (Z-axis direction) or may extend at an angle relative to the vertical direction. The lower end of the connecting plate portion 52c is connected to the rear end of the inner plate portion 52a. The upper end of the connecting plate 52c is connected to the front end of the outer plate portion 52b.

The first bent portion 55 includes a connecting plate portion 52c, a bent connecting portion (bent portion) between the connecting plate portion 52c and the inner plate portion 52a, and a bent connecting portion (bent portion) between the connecting plate portion 52c and the outer plate portion 52b.

Further, a dimension L1 in the front-rear direction between the connecting plate portion 52c and the connecting plate 91e is larger than a dimension T1 in the vertical direction (that is, a plate thickness dimension) of the connecting plate 91e. In other words, the front-rear direction distance between the first terminal 91 and the first bent portion 55 is greater than the thickness dimension of the first terminal 91 in the vertical direction.

The second bend 56 is located between the portion of the fuse element 50 that faces the insulating member 60 and the second terminal 92. In other words, the second bend 56 is positioned between the insulating member 60 and the second terminal 92 in the front-rear direction. Specifically, the second fold 56 is provided on the third element 53.

Specifically, the third element 53 has an inner plate portion 53a connected to the first element 51, an outer plate portion 53b connected to the second terminal 92, and a connecting plate portion 53c connecting the inner plate portion 53a and the outer plate portion 53b.

The inner plate portion 53a is plate-shaped extending in a plane direction (X-Y plane direction) perpendicular to the vertical direction. The rear end of the inner plate portion 53a is connected to the second end 51b of the first element 51 by soldering or the like using connecting metal 86.

The outer plate portion 53b is plate-shaped, extending in the plane direction perpendicular to the vertical direction (X-Y plane direction). The outer plate portion 53b is positioned in front of and above the inner plate portion 53a. The front end of the outer plate portion 53b is connected to the connection plate 92e of the conductor connecting portion 92c by soldering or the like.

The connecting plate portion 53c is plate-shaped, extending in a plane direction perpendicular to the front-rear direction (Y-Z plane direction). The connection plate 53c may extend in a plane direction inclined to the Y-Z plane. That is, in a cross-sectional view perpendicular to the left-right direction (Y-axis direction) as illustrated in FIG. 4, the connecting plate portion 53c may extend along the vertical direction (Z-axis direction) or at an angle to the vertical direction. The lower end of the connecting plate 53c is connected to the front end of the inner plate portion 53a. The upper end of the connecting plate portion 53c is connected to the rear end of the outer plate portion 53b.

The second bent portion 56 includes a connecting plate portion 53c, a bent connecting portion (bend) between the connecting plate portion 53c and the inner plate portion 53a, and a bent connecting portion (bend) between the connecting plate portion 53c and the outer plate portion 53b.

The front-rear dimension L2 between the connecting plate portion 53c and the connecting plate 92e is larger than the vertical dimension of the connecting plate 92e (that is, the thickness dimension) T2. In other words, the front-rear direction distance between the second terminal 92 and the second bend 56 is greater than the vertical thickness dimension of the second terminal 92.

At least one of the first bent portion 55 and the second bent portion 56 has a crank shape. In the present embodiment, both the first bent portion 55 and the second bent portion 56 have a bent crank shape.

### (Insulating Member)

As illustrated in FIG. 3 to FIG. 5, the insulating member 60 is plate-shaped, with a pair of plate surfaces facing in the vertical direction. In the present embodiment, the insulating member 60 has a rectangular plate shape with a left-right dimension larger than the front-rear dimension when viewed from the vertical direction. The insulating member 60 is composed of a resin having a tracking resistance index CTI of 500V or more. The insulating member 60 is composed of a polyamide resin material or a fluorine resin material. An example of the resin material constituting the insulating member 60 is the same as that of the insulating case 10 (the cover 10A and each of the holding members 10B to 10D) described above.

As illustrated in FIG. 4, the insulating members 60 are disposed facing the fuse element 50 from both the upper and lower sides. The insulating member 60 is disposed in close proximity to or in contact with the fuse element 50. The vertical dimension between the insulating member 60 and the fuse element 50 is, for example, 2 mm or less. The vertical dimension between the insulating member 60 and the fuse element 50 is preferably 1.5 mm or less, and more preferably 1 mm or less.

At least two insulating members 60 are provided on the upper and lower sides of the fuse element 50. That is, at least a pair of insulating members 60 are disposed so as to sandwich the fuse element 50 from above and below. In the present embodiment, two fuse elements 50 are provided side by side in the vertical direction, and insulating members 60 are provided above and below the upper fuse element 50 and above and below the lower fuse element 50, respectively.

More specifically, the insulating member 60 located below the upper fuse element 50 and the insulating member 60 located above the lower fuse element 50 are the same part (a common part). Therefore, the fuse elements 50 and the insulating members 60 are disposed alternately in the vertical direction.

In addition, the insulating member 60 located below the lower fuse element 50 is formed integrally with the first holding member 10B. Specifically, the insulating member 60 located below the lower fuse element 50 is formed by a portion of the bottom wall 10a of the first holding member 10B. That is, at least one of the insulating members 60 is formed integrally with a portion of the insulating case 10.

Although not particularly illustrated, the insulating member 60 located above the upper fuse element 50 may be formed integrally with the second holding member 10C. That is, one or both of the two holding members 10B and 10C are formed integrally with the insulating member 60.

The bottom wall 10a (insulating member 60) may have a groove-shaped recess portion 19 recessed from the surface (upper surface) of bottom wall 10a facing fuse element 50. A pair of recesses 19 is provided on the front side and rear side of the first element 51. The recess portion 19 extends in the left-right direction. That is, the recess portion 19 extends in a direction orthogonal to the current flow direction of the fuse element 50 (which in the present embodiment is generally the front-rear direction, and partially includes the vertical direction).

As illustrated in FIG. 3 to FIG. 5, the insulating member 60 has a heating element housing portion 61, a conductor-facing recess portion 62, a slit portion 63, and a ventilation hole 64.

The heating element housing portion 61 is recessed from the surface of the insulating member 60 facing the fuse element 50. In the present embodiment, the heating element housing portion 61 is formed by being recessed upward from the lower surface, which faces the fuse element 50, of the pair of plate surfaces (upper and lower surfaces) of the insulating member 60.

In the present embodiment, the heating element housing portion 61 is disposed in the center of the insulating member 60 in the front-rear direction. The heating element housing portion 61 is a rectangular hole that is long in the left-right direction.

The conductor-facing recess portion 62 is recessed from the surface of the insulating member 60 facing the fuse element 50. In the present embodiment, the conductor-facing recess portion 62 is formed by a pair of plates (top surface and bottom surface) of the insulating member 60 that are recessed downward from the top surface facing the fuse element 50.

In the present embodiment, the conductor-facing recess portion 62 is located in the center of the insulating member 60 in the front-rear direction. Specifically, the conductor-facing recess portion 62 is disposed facing the first element 51 of the fuse element 50. The dimension of the conductor-facing recess portion 62 in the front-rear direction is smaller than the dimension of the heating element housing portion 61 in the front-rear direction. The vertical dimension (depth dimension) of the conductor-facing recess portion 62 is smaller than the vertical dimension of the heating element housing portion 61.

The insulating member 60 may also have a slit portion 63. The slit portion 63 is recessed from the surface of the insulating member 60 facing the fuse element 50 and has a slit shape penetrating the insulating member 60. That is, the slit portion 63 is slit-shaped, penetrates the insulating member 60 in the vertical direction, and opens on each of a pair of plate surfaces (upper and lower surfaces). A pair of slits 63 is provided on the front side and rear side of the first element 51. The slit portion 63 extends in the left-right direction. That is, the slit portion 63 extends in a direction orthogonal to the current flow direction of the fuse element 50 (which in the present embodiment is generally the front-rear direction, and partially includes the vertical direction).

When the slit portion 63 is disposed in the insulating member 60, the molten debris of the fuse element that adheres to the surface of the insulating member 60 facing the fuse element 50 after the fuse element 50 is interrupted becomes discontinuous at the slit portion 63, thereby making it possible to suitably increase the insulation resistance between the first terminal 91 and the second terminal 92 after the fuse element 50 is interrupted.

The ventilation hole 64 passes through the insulating member 60 in the vertical direction. A plurality of ventilation holes 64 is provided in the insulating member 60. The plurality of ventilation holes 64 is disposed at both ends of the insulating member 60 in the left-right direction.

In the present embodiment, the chamber 18 in which the fuse element 50 is housed communicates with the internal pressure buffer space 16 via the slit portion 63 and the ventilation hole 64. Therefore, when an arc discharge occurs and pressure rises in the chamber 18 when the fuse element 50 cuts off an overcurrent, this pressure can be efficiently released into the internal pressure buffering space 16 through the slit portion 63 and the ventilation hole 64.

### (Heating Element)

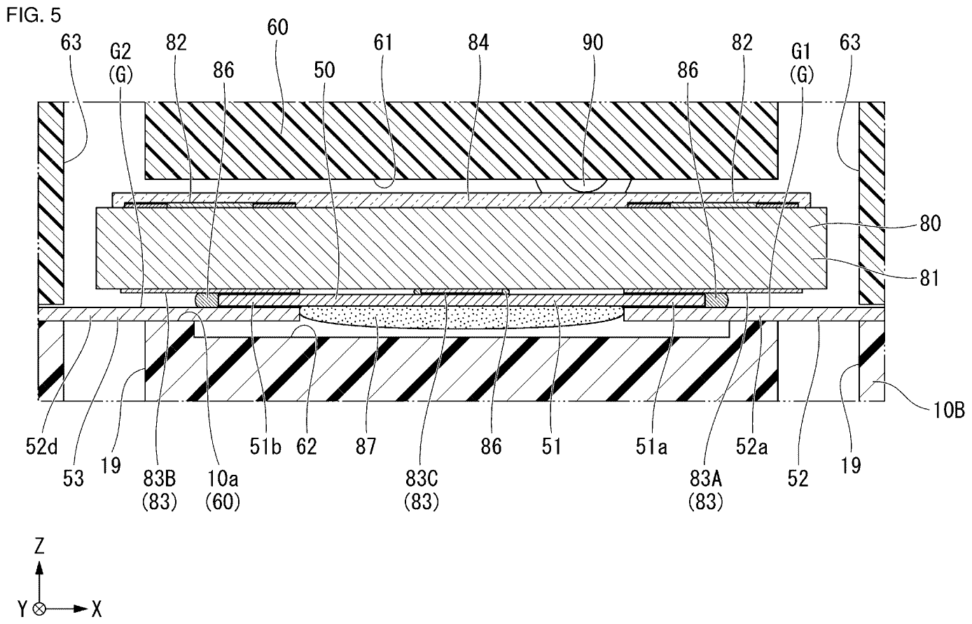

As illustrated in FIG. 4 and FIG. 5, the heating element 80 is disposed so as to overlap the fuse element 50 in the vertical direction. The heating element 80 contacts the fuse element 50 in the vertical direction.

The heating element 80 generates heat when current is applied from the power supply member 90, melting and blowing at least a portion of the fuse element 50. Specifically, the heating element 80 is stacked on the first element 51 in the vertical direction, and at least a portion of the first element 51 melts and blows due to heat generated by energization. In the present embodiment, “melting and blowing at least a portion of the fuse element 50” may be abbreviated to “melting and blowing the fuse element 50” or the like in the description. In some cases, “melting and blowing at least a portion of the first element 51” is abbreviated to “melting and blowing the first element 51” or the like. The same as above applies to both the second element 52 and the third element 53.

The heating element 80 is provided in the same number as the fuse element 50. In the present embodiment, two heating elements 80 are provided side by side in the vertical direction. Each heating element 80 contacts a respective fuse element 50.

As illustrated in FIG. 3 to FIG. 6B, heating element 80 is plate-shaped, with a pair of plate faces facing vertically. In the present embodiment, the heating element 80 has a rectangular plate shape with a left-right dimension that is larger than the front-rear dimension when viewed from the vertical direction. The heating element 80 is disposed in the heating element housing portion 61. That is, the heating element 80 is housed in the insulating member 60.

The heating element 80 has an insulating substrate (substrate) 81, a resistive layer 82 laminated on insulating substrate 81, a metal layer 83 laminated on insulating substrate 81 and facing the fuse element 50 in the vertical direction, an insulating layer 84, and a heating element electrode 85. In the present embodiment, the heating element 80 extends in the left-right direction, and the insulating substrate 81, the resistive layer 82, the metal layer 83, and the insulating layer 84 also extend in the left-right direction.

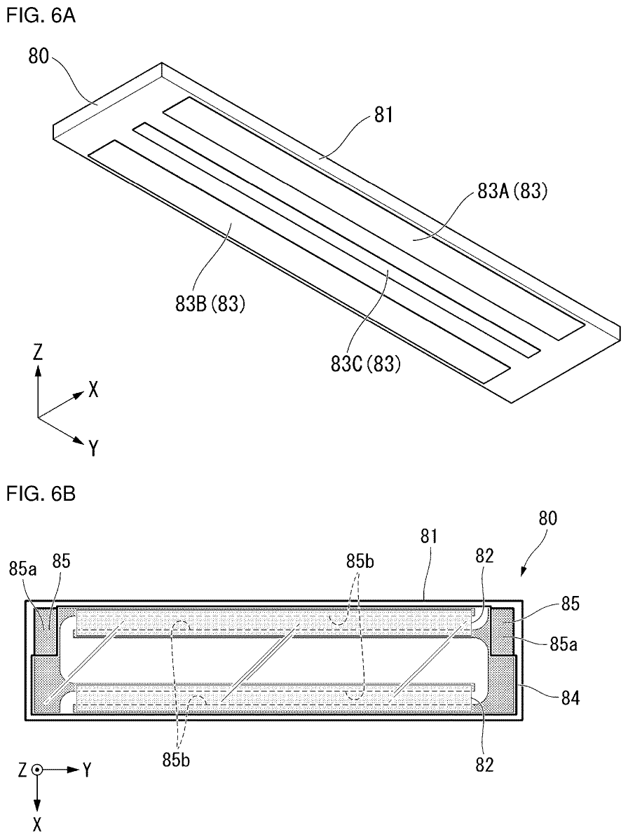

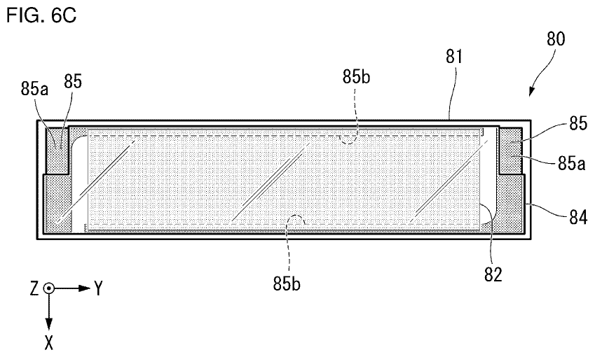

Specifically, as illustrated as one example in FIG. 6B, the heating element 80 has two resistive layers 82 disposed at a distance in the front-to-rear direction on the upper surface of an insulating substrate 81 and extending parallel to each other, an insulating layer 84 covering these resistive layers 82 from above, a pair of heating element electrodes 85 formed on the insulating substrate 81 and electrically connected to both ends of the resistive layers 82 in the left-right or front-to-rear direction, and a metal layer 83 disposed on the lower surface of the insulating substrate 81 (see FIG. 6A).

In the present embodiment, as illustrated in FIG. 6B, the heating element electrode 85 has a first electrode portion 85a extending in the front-rear direction, and a second electrode portion 85b connected to the first electrode portion 85a and extending in the left-right direction.

The first electrode portion 85a is disposed on the upper surface of the insulating substrate 81 at the ends in the left-right direction. At least a portion of the first electrode portion 85a is not covered by the insulating layer 84 and is exposed to the outside of the heating element 80.

In the example illustrated in FIG. 6B, each heating element electrode 85 is provided with a pair of second electrode portions 85b spaced apart from each other in the front-rear direction. Further, second electrode portions 85b of a pair of heating element electrodes 85 are connected to both ends of the resistive layer 82 in the front-rear direction.

As illustrated in FIG. 5 and FIG. 6A, the metal layer 83 is disposed on one (the lower surface in the present embodiment) of a pair of plate surfaces (upper and lower surfaces) of the insulating substrate 81, and the resistive layer 82 is disposed on the other (the upper surface in the present embodiment) of the pair of plate surfaces. The metal layer 83 may be referred to as an electrode (dummy electrode) or the like.

The resistive layer 82 is made of a conductive material that generates heat when a current is passed through it, such as nichrome, W, Mo, Ru, or a material containing these. The resistive layer 82 is formed by mixing a powder of an alloy, composition, or compound of these with a resin binder or the like to form a paste, forming a pattern on the insulating substrate 81 using a screen printing technique, and then firing, or the like.

The insulating substrate 81 is an insulating substrate such as alumina, glass ceramic, mullite, or zirconia. The insulating layer 84 is provided to protect the resistive layer 82. The insulating layer 84 may be composed of an insulating material such as ceramics or glass. The insulating layer 84 may be formed, for example, by method for coating and firing a glass-based paste, or the like.

The heating element electrode 85 and the resistive layer 82 on the upper surface of the heating element 80 are electrically insulated from the metal layer 83 on the lower surface by an insulating substrate 81.

When it becomes necessary to cut off the electrical current path, such as due to an abnormality occurring in the external circuit that serves as the electrical current path of the protection element 100, the heating element 80 is energized and heated by a current control element provided in the external circuit.

As illustrated in FIG. 5, a portion of the first element 51 of the fuse element 50 is disposed in a portion of the vertical gap G formed between each of the second element 52 and the third element 53 and the metal layer 83, and is sandwiched between each of the second element 52 and the third element 53 and the metal layer 83 in the vertical direction. The gap G is a dimension that is the same as or slightly larger than the vertical dimension (thickness dimension) of the first element 51, specifically, for example, several +μm to several hundred m, and in the present embodiment, it is approximately 50 μm to 100 μm. The gap G may have any dimension that allows capillary action to occur, as described below.

In FIG. 5, reference numeral 86 indicates a connecting metal for mounting, and reference numeral 87 indicates an insulating flux. As illustrated in FIG. 5, the metal layer 83, the first element 51, the second element 52, and the third element 53 are connected to each other and fixed by a connecting metal 86.

Specifically, as illustrated in FIG. 5 and FIG. 6A, a plurality of metal layers 83 is provided on the heating element 80. The multiple metal layers 83 are disposed at intervals from one another in the front-rear direction. The multiple metal layers 83 include a first metal layer 83A disposed vertically away from the second element 52 with a first gap G1 therebetween, and a second metal layer 83B disposed vertically away from the third element 53 with a second gap G2 therebetween.

The plurality of (two) resistive layers 82 provided on the upper surface of the insulating substrate 81 overlap the first metal layer 83A and the second metal layer 83B, respectively, when viewed from the vertical direction. Therefore, when power is supplied from the power supply member 90 to the heating element electrode 85 and each resistive layer 82 generates heat, the heat is transferred through the insulating substrate 81 to the first metal layer 83A and the second metal layer 83B, and these metal layers 83A, 83B are heated.

Note that one resistive layer 82 may be provided alone on the insulating substrate 81, as in another example of a heating element 80 illustrated in FIG. 6C. In this case, one resistive layer 82 is disposed so as to overlap at least a portion of the first metal layer 83A and the second metal layer 83B when viewed from the vertical direction. Preferably, one resistive layer 82 is positioned overlapping both the first metal layer 83A and the second metal layer 83B, viewed from the vertical directions. One resistive layer 82 may be disposed over the entire upper surface of the insulating substrate 81. In the example illustrated in FIG. 6C, each heating element electrode 85 includes one second electrode portion 85b.

As illustrated in FIG. 5, the first end 51a of the first element 51 is disposed in a portion of the first gap G1, and is sandwiched between the second element 52 and the first metal layer 83A in the vertical direction.

The second end 51b of the first element 51 is placed in a portion of the second gap G2 and is sandwiched between the third element 53 and the second metal layer 83B in the vertical direction.

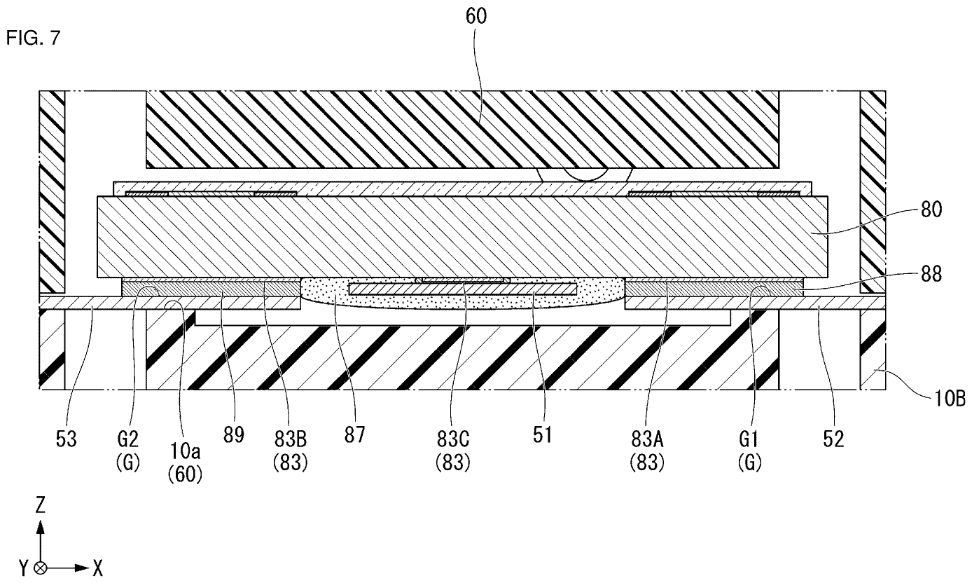

Here, FIG. 7 illustrates a state in which a portion of the fuse element 50 has blown due to heat generated by the heating element 80 in response to an interrupt signal.

Molten material 88 near the first end 51a of the first element 51 (including the first end 51a of the first element 51 and the connecting metal 86) melts due to the heat generated by the heating element 80, and flows toward the rear while penetrating into the first gap G1 due to capillary action. Molten material 89 near the second end 51b of the first element 51 (the melt including the second end 51b of the first element 51 and the connecting metal 86) flows toward the front while entering the second gap G2 by capillary action. As a result, the first element 51 is blown so as to be divided in the front-rear direction, and the current flow through the fuse element 50 is interrupted. That is, in the present embodiment, the molten materials 88 and 89 of the first element 51 melted by the heat generated by the heating element 80 flow while penetrating into the gap G due to capillary action, whereby the first element 51 melts.

As illustrated in FIG. 5 and FIG. 6A, the multiple metal layers 83 further include an intermediate metal layer 83C disposed between the first metal layer 83A and the second metal layer 83B. The intermediate metal layer 83C is disposed between the first metal layer 83A and the second metal layer 83B in the front-rear direction. Furthermore, the dimension in the front-rear direction of the intermediate metal layer 83C is smaller than the dimension in the front-rear direction of the first metal layer 83A, and is smaller than the dimension in the front-rear direction of the second metal layer 83B.

An intermediate portion of first element 51 located between first end 51a and second end 51b is connected by connecting metal 86 to intermediate metal layer 83C. As illustrated in FIG. 7, when the heating element 80 generates heat in response to an interrupt signal, the intermediate portion of the first element 51 located between the first end 51a and the second end 51b remains connected to the intermediate metal layer 83C.

When the amount of heat generated by the heating element 80 is large, (the foregoing intermediate portion of) the first element 51 connected to the intermediate metal layer 83C also melts, and a portion of the molten material of the first element 51 is held on the surface of the intermediate metal layer 83C.

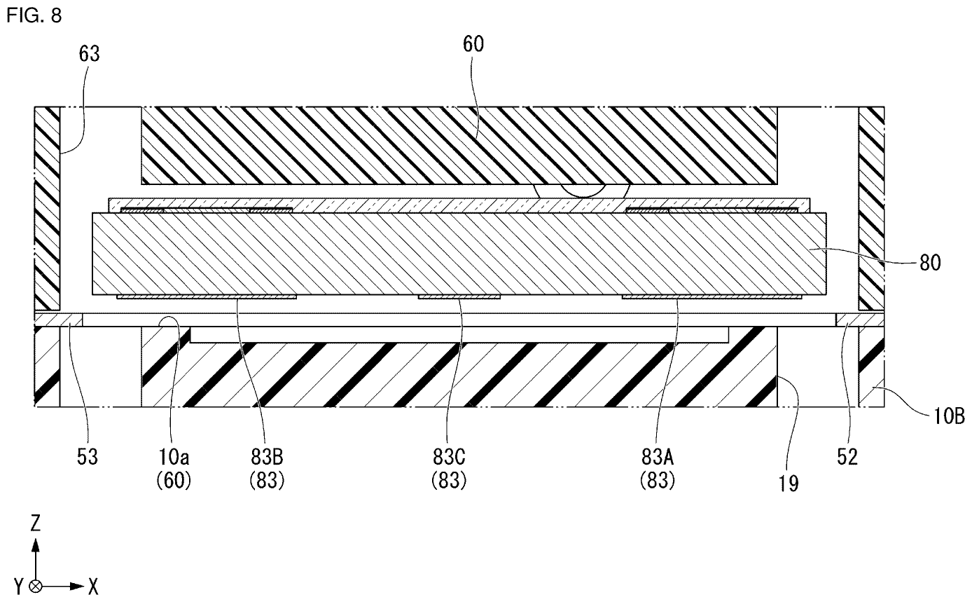

FIG. 8 illustrates a state in which a portion of the fuse element 50 has been blown (been lost) due to an overcurrent (current equal to or greater than a predetermined value) that exceeds the rated current. As illustrated in FIG. 8, when a current greater than or equal to a predetermined value flows through fuse element 50, at least a portion of first element 51, or at least a portion of first element 51 and at least a portion of each of second element 52 and third element 53, is blown, and current flow through fuse element 50 is cut off. In the example illustrated in FIG. 8, at least a portion of the first element 51 and at least a portion of each of the second element 52 and the third element 53 have been blown, and more specifically, the entire first element 51, the front end of the second element 52, and the rear end of the third element 53 have been lost due to overcurrent.

### (Power Supply Member)

As illustrated in FIG. 2, the power supply member 90 is a member that supplies power to the heating element 80. The power supply member 90 extends from the outside to the inside of the insulating case 10, and one end thereof is connected to the heating element electrode 85 of the heating element 80. Specifically, one end of the power supply member 90 is connected to the first electrode portion 85a of the heating element electrode 85. One end of the power supply member 90 and the first electrode portion 85a of the heating element electrode 85 are connected by, for example, solder. Part or all of the connecting portion between one end of the power supply member 90 and the first electrode portion 85a of the heating element electrode 85 may be fixed so as to be covered with adhesive, and a portion of the adhesive may also be adhered to the insulating member 60. This prevents the solder connecting the power supply member 90 and the first electrode portion 85a of the heating element electrode 85 from melting and interrupting the electrical current before the fuse element 50 melts when current is applied to the heating element 80. In the present embodiment, at least a portion of the power supply member 90 is configured by an electric wire (wiring member). However, the present invention is not limited thereto, and although not specifically illustrated, at least a portion of the power supply member may be composed of a conductive plate member, rod member, or the like.

### Effect of Present Embodiment

The fuse element 50 of the present embodiment described above has a first element 51 made of silver or copper, or an alloy mainly composed of silver or copper, a second element 52 made of silver or copper, or an alloy mainly composed of silver or copper, and connected in series to the first element 51 on the current path, a third element 53 made of silver or copper, or an alloy mainly composed of silver or copper, and connected in series with the first element 51 on the current path, a connecting metal 86 composed of tin or an alloy mainly composed of tin, connecting one end 51a of the first element 51 and one end of the second element 52, and the connecting metal 86 connecting another end 51b of the first element 51 and one end of the third element 53.

According to this configuration, when interrupting a relatively small overcurrent, such as 1.5 times the rated current, the combination of first element 51 (hereinafter also referred to as silver foil element 51) made of silver or an alloy mainly composed of silver and connecting metal 86 (hereinafter also referred to as tin connecting metal 86) made of tin or an alloy mainly composed of tin makes it possible for the fuse element to blow at about 300° C. As a result, even when the insulating case 10 is a plastic case with a melting point of approximately 300° C., damage to the case can be suppressed. Furthermore, by using the thin silver foil element 51 as the blowing portion, the amount of molten material scattered when a high voltage and large current is interrupted can be reduced. This makes it possible to reduce the scale of arc discharge and to improve the insulation resistance. In addition, in the heater blowing method, the combination of the silver foil element 51 and the connecting metal 86 composed of tin enables the fuse element 50 to blow at about 300° C. Therefore, it is possible to provide a fuse element 50 that melts at a low temperature of about 300° C., has a small molten volume, and is easy to cut.

Furthermore, the silver foil element 51 has better compatibility with solder than copper, and the silver foil melts when the solder melts, thereby interrupting the current flow through the fuse element 50. Furthermore, the silver foil is thin (has a small volume), and thus deterioration of the insulation resistance due to sublimation during interruption of an overcurrent can be suppressed.

Furthermore, as a result of careful investigation, the present inventors have come to the conclusion that similar effects can be obtained when the first element 51 is composed of copper foil, as in the second element 52 and the third element 53 (that is, it is possible to provide a fuse element that melts at a low temperature of about 300° C., has a small molten volume, and is easy to cut). That is, the same effects as those of the silver foil element 51 can be obtained by combining the first element 51 (copper foil element 51) composed of copper or an alloy mainly composed of copper with the connecting metal 86 composed of tin.

Furthermore, by including the fuse element 50 in the protection element 100 of the present embodiment, it is possible to provide a protection element 100 that achieves both overcurrent blocking and active blocking.

In the present embodiment, the heat generated by the overcurrent flowing in the fuse element 50 melts the connecting metal 86, and the molten material of the connecting metal 86 melts one end 51a or the other end 51b of the first element 51, thereby blowing at least the first element 51.

According to this configuration, it is possible to blow at least the first element 51 by simply melting the end of the first element 51 due to the heat generated by the overcurrent flowing through the fuse element 50, so there is no need to melt the entire fuse element 50. This is therefore suitable for providing a fuse element 50 that has a small melting volume and is easy to cut.

In the present embodiment, the thickness Z1 of the first element 51 is thinner than each of the thicknesses Z2 of the second element 52 and Z3 of the third element 53.

According to this configuration, the first element 51 is easier to melt down compared to a case in which the thickness Z1 of the first element 51 is greater than each of the thickness Z2 of the second element 52 and the thickness Z3 of the third element 53. This is therefore suitable for providing a fuse element 50 that has a small melting volume and is easy to cut.

Furthermore, in the present embodiment, the thickness Z1 of the first element 51 is less than half of each of the thicknesses Z2 of the second element 52 and Z3 of the third element 53.

According to this configuration, the first element 51 blows more readily than when the thickness Z1 of the first element 51 is more than half of each of the thickness Z2 of the second element 52 and the thickness Z3 of the third element 53. This is therefore suitable for providing a fuse element 50 that has a small melting volume and is easy to cut.

The present embodiment also has a heating element 80, which melts the connecting metal 86 when the heating element 80 generates heat, and the molten material of the connecting metal 86 melts one end 51a or the other end 51b of the first element 51, thereby blowing at least the first element 51.

According to this configuration, there is no need to dissolve the entire fuse element 50, because the heat generated by the heating element 80 can blow at least the first element 51 by simply melting the end of the first element 51. This is therefore suitable for providing a fuse element 50 that has a small melting volume and is easy to cut.

The present embodiment also has a plurality of fuse elements 50, and the plurality of fuse elements 50 is connected in parallel between the first terminal 91 and the second terminal 92.

According to this configuration, each of the multiple fuse elements 50 is insulated by being in close proximity to or in contact (close contact) with the insulating member 60 disposed therebetween, and the space surrounding the multiple fuse elements 50 becomes extremely narrow. This tends to reduce the scale of arc discharge caused by blowing. In other words, when the blowing space is narrow, there is less gas in the space, and the amount of “plasma generated by ionization of the gas in the space,” which serves as a path for current to flow during arc discharge, will also be less, making it easier to extinguish the arc discharge early. Therefore, according to the protection element 100 of the present embodiment, the size and weight of the insulating case 10 can be reduced.

Furthermore, in the protection element 100 of the present embodiment, when an overcurrent exceeding the rated current (that is, a current equal to or greater than a predetermined value) flows through the fuse element 50, the fuse element 50 heats up and melts, thereby interrupting the current path. Alternatively, this protection element 100 can cut off the current path by passing a current through the heating element 80 to generate heat, thereby melting and blowing the fuse element 50 laminated on the heating element 80.

In the present embodiment, insulating members 60 are disposed facing each other on both sides of the fuse element 50 in the vertical direction. Specifically, the insulating member 60 is in close proximity to or in contact with the fuse element 50 from above and below, and preferably in intimate contact therewith. As a result, there is no space between the fuse element 50 and the insulating member 60 in which the arc discharge can continue, and the arc discharge is reliably extinguished when an overcurrent is interrupted.

As described above, according to the present embodiment, it is possible to prevent a large-scale arc discharge from occurring when the fuse element 50 melts, and it is possible to provide a protection element 100 that achieves both an overcurrent interrupt function and a interrupt function based on an interrupt signal.

In the present embodiment, the vertical dimension between the insulating member 60 and the fuse element 50 is 2 mm or less.

In this case, since the space formed between the fuse element 50 and the insulating member 60 is narrow, the scale of the arc discharge generated when the fuse element 50 melts due to an overcurrent interruption tends to be small. In other words, when the blowing space is narrow, there is less gas in the space, and the amount of “plasma generated by ionization of the gas in the space,” which serves as a path for current to flow during arc discharge, will also be less, making it easier to extinguish the arc discharge early. More preferably, the above dimension is 1.5 mm or less, and even more preferably, 1 mm or less.

In the present embodiment, the insulating member 60 has a heating element housing portion 61, and the heating element 80 is disposed in the heating element housing portion 61.

In this case, by housing the heating element 80 in the heating element housing portion 61, a portion of the surface of the insulating member 60 facing the fuse element 50 other than the heating element housing portion 61 can be positioned closer to or in contact with the fuse element 50. This eliminates the space between the fuse element 50 and the insulating member 60 where arcing can continue, and arcing is more reliably suppressed.

Furthermore, in the present embodiment, the insulating member 60 has a slit portion 63 recessed from the surface of the insulating member 60 facing the fuse element 50 and penetrating the insulating member 60, or a groove-shaped recess portion 19 recessed from the upper surface of the bottom wall 10a (corresponding to the lowermost insulating member 60 among the multiple insulating members 60) facing the fuse element 50. The slit portion 63 or the recessed portion 19 extends in a direction orthogonal to the current flow direction of the fuse element 50.

In this case, by providing the slit portion 63 or the recess portion 19, it is possible to prevent the molten debris that scatters around when the fuse element 50 melts due to an overcurrent interruption from being continuously formed on the surface of the insulating member 60 facing the fuse element 50. This makes it possible to stably increase the insulation resistance after the current path is interrupted.

In the present embodiment, at least two insulating members 60 are provided on the upper and lower sides of the fuse element 50, and at least one of the insulating members 60 is integrally formed with a portion of the insulating case 10.

Specifically, the insulating member 60 is integrated with the holding member 10B (a portion of the insulating case 10). This makes it possible to reduce the number of parts, facilitate the manufacture of the protection element 100, and reduce the manufacturing costs.

In the present embodiment, the insulating case 10 has an internal pressure buffer space 16 that is formed inside the insulating case 10 and communicates with a chamber (space) 18 in which the fuse element 50 is disposed.

In this case, the internal pressure buffer space 16 can suppress a sudden increase in the internal pressure of the protection element 100 due to gas generated by the arc discharge that occurs when the fuse element 50 melts. This can prevent damage to the insulating case 10, and the like.

Furthermore, in the present embodiment, a portion of the first element 51 is disposed in a portion of the vertical gap G formed between each of the second element 52 and the third element 53 and the metal layer 83 in the vertical direction. The metal layer 83 is sandwiched between each of the second element 52 and the third element 53 and the metal layer 83 in the vertical direction.

In this case, the resistive layer (heater) 82 generates heat when electricity is applied, and this heat is transferred to the metal layer (dummy electrode) 83 via the insulating substrate (heater substrate) 81, and a portion of the first element 51 melts between the metal layer 83 and each of the second element 52 and the third element 53. The first element 51 can be efficiently melted and reliably blown by the interrupt signal.

Furthermore, in the present embodiment, the molten material 88 and 89 of the first element 51 melted by the heat generated by the heating element 80 flows while entering the gap G by capillary action, thereby blowing the first element 51.

In this case, the molten materials 88 and 89 of the first element 51 are sucked into the gap G between the second element 52 and the third element 53 and the metal layer 83 by capillary action, thereby causing the molten materials 88 and 89 to flow in the desired direction, thereby more reliably blowing the first element 51.

Furthermore, in the present embodiment, specifically, the first end 51a of the first element 51 is positioned in a portion of the first gap G1 and is sandwiched between the second element 52 and the first metal layer 83A in the vertical direction, and the second end 51b of the first element 51 is positioned in a portion of the second gap G2 and is sandwiched between the third element 53 and the second metal layer 83B in the vertical direction.

In this case, the heat generated by the heating element 80 melts the vicinity of the first end 51a of the first element 51 between the first metal layer 83A and the second element 52, and melts the vicinity of the second end 51b of the first element 51 between the second metal layer 83B and the third element 53. The first element 51 melts at both ends in the current flow direction, and thus the fuse element 50 can be more reliably blown by an interrupt signal.

Furthermore, in the present embodiment, specifically, the molten material 88 near the first end 51a of the first element 51, which has melted due to the heat generated by the heating element 80, flows while penetrating into the first gap G1 due to capillary action, and molten material 89 near the second end 51b of the first element 51 flows while penetrating into the second gap G2 due to capillary action, thereby blowing the first element 51.

In this case, the molten materials 88 and 89 of the first element 51 flow while being sucked in by capillary action near both ends in the current flow direction, so that the first element 51 is blown more reliably.

Furthermore, in the present embodiment, the multiple metal layers 83 further include an intermediate metal layer 83C, and an intermediate portion of the first element 51 located between the first end 51a and the second end 51b is connected to the intermediate metal layer 83C.

In the above configuration, even when the first element 51 is blown near both ends in the current flow direction as described above, the middle portion of the first element 51 remains held by the intermediate metal layer 83C. This allows the first element 51 to be blown more reliably.

Specifically, by providing the intermediate metal layer 83C, the first element 51 after melting is divided into three portions: a portion 88 (near the first end 51a) disposed in the first gap G1, a portion 89 (near the second end 51b) disposed in the second gap G2, and a portion held by the intermediate metal layer 83C (near the middle portion). By dividing the first element 51 into three divided bodies, the capacity (volume) of each divided body is reduced, and the amount of melt is also reduced, making it easier to control the flow of the molten material.

More specifically, for example, the intermediate metal layer 83C of the present embodiment can suppress problems such as the molten material of the first element 51 gathering near the left-right center of the first element 51 due to the action of surface tension, creating an unintended lump, or flowing while rotating in the X-Y plane, causing the current interrupt of the first element 51 to become unstable.

Furthermore, in the present embodiment, the fuse element 50 has a first bent portion 55 disposed between the first terminal 91 and the insulating member 60 in the front-to-rear direction, and a second bent portion 56 disposed between the second terminal 92 and the insulating member 60 in the front-to-rear direction, wherein a front-rear direction distance L1 between the first terminal 91 and the first bent portion 55 is greater than a vertical thickness dimension T1 of the first terminal 91, and front-rear direction distance L2 between the second terminal 92 and the second bent portion 56 is greater than a vertical thickness dimension T2 of the second terminal 92.

In the present embodiment, a configuration is adopted in which the fuse element 50 is sandwiched between insulating members 60 from above and below, thereby eliminating as much air as possible from the space (interruption space) around the blown portion of the fuse element 50, thereby suppressing the amount of air plasma generated, which serves as a path for arc discharge when an overcurrent is cut off. However, on the other hand, when the front-rear direction distance between the first terminal 91 and the second terminal 92 changes due to thermal expansion, thermal contraction, or the like accompanying a change in the ambient temperature in which the protection element 100 is installed, it is possible that the fuse element 50 will not be able to adequately follow this change and may break. In particular, as in the present embodiment, the first terminal 91 and the second terminal 92 are positioned on a resin holding member 10B, and may be susceptible to thermal expansion and contraction due to temperature changes in the holding member 10B, or may be affected by changes in the position of components such as a bus bar outside the protection element 100 to which the first terminal 91 and the second terminal 92 are connected.

In this regard, in the present embodiment, the fuse element 50 is provided with the first bent portion 55 and the second bent portion 56, so that even when the front-rear direction distance between the first terminal 91 and the second terminal 92 changes due to a change in the ambient temperature or the like in the area where the protection element 100 is installed, the first bent portion 55 and the second bent portion 56 can expand and contract the front-to-rear dimension of the fuse element 50. In other words, it is possible to use a simple structure to cause the fuse element 50 to follow the change in the distance between the terminals 91 and 92.

Specifically, the front-rear direction distance L1 between the first terminal 91 and the first bend 55 is larger than the vertical thickness dimension T1 of the first terminal 91. Therefore, even when the solder or the like connecting the fuse element 50 and the first terminal 91 protrudes from the first terminal 91 toward the fuse element 50, it is prevented from reaching the first bent portion 55. This prevents the first bent portion 55 and the first terminal 91 from being stuck together, and ensures that the expansion and contraction function of the fuse element 50 due to the first bent portion 55 is stable and effective.

Furthermore, the front-rear direction distance L2 between the second terminal 92 and the second bend 56 is larger than the vertical thickness dimension T2 of the second terminal 92. This prevents solder or the like connecting the fuse element 50 and the second terminal 92 from reaching the second bend 56 even when it protrudes from the second terminal 92 to the fuse element 50 side. This suppresses the problem of sticking of the second bend 56 to the second terminal 92, and the expansion and contraction function of the fuse element 50 by the second bend 56 is stably performed.

Therefore, according to the present embodiment, it is possible to suppress the occurrence of a large-scale arc discharge when the fuse element 50 melts, while reliably preventing malfunctions such as the fuse element 50 being broken due to excessive loads such as tension or compression acting on the fuse element 50 due to temperature changes, and the like.

Furthermore, in the present embodiment, at least one of the first bent portion 55 and the second bent portion 56 has a crank shape.

In this case, the expansion and contraction function of the fuse element 50 due to the first bent portion 55 or the second bent portion 56 is more stably achieved.

Furthermore, in the present embodiment, the insulating case 10 has at least two holding members 10B, 10C disposed on both sides of the fuse element 50 in the vertical direction, and a portion of the first terminal 91, a portion of the second terminal 92, and the fuse element 50 are disposed between the two holding members 10B, 10C, and one or both of the two holding members 10B, 10C are formed integrally with the insulating member 60.

In this case, the insulating member 60 is integrated with a portion of the insulating case 10. This makes it possible to reduce the number of parts, facilitate the manufacture of the protection element 100, and reduce the manufacturing costs.

In the present embodiment, the insulating case 10 has the cover 10A that houses at least two holding members 10B to 10D, and the cover 10A holds the at least two holding members 10B to 10D in a fixed state.

In this case, by housing the multiple holding members 10B to 10D in the cover 10A, these holding members 10B to 10D are maintained in a fixed state to one another. The postures of a portion of the first terminal 91, a portion of the second terminal 92, and the fuse element 50 disposed between the multiple holding members 10B, 10C are stabilized.

Furthermore, in the present embodiment, the insulating member 60 is composed of resin with a tracking resistance index CTI of 500 V or higher.

In this case, carbides that serve as conductive paths are less likely to be formed on the surface of the insulating member 60 by arc discharge, making it more difficult for leakage current to occur.

Furthermore, in the present embodiment, the insulating member 60 is composed of polyamide resin material or fluorine resin material.

Resin materials have a lower heat capacity and lower melting point than, for example, ceramic materials or the like. When a resin material is used as the material for the insulating member 60 as in the present embodiment, it has the property of weakening the arc discharge caused by gasification cooling (ablation), and when the melted and scattered metal particles adhere to the insulating member 60, the surface of the insulating member 60 is deformed or the adhered matter aggregates, making the metal particles sparse and making it difficult to form a conductive path, which is preferable.

The present invention is not limited to the embodiments described above, and the configuration can be modified or the like within a scope that does not department from the essence of the present invention, for example, as described below. Note that in illustrating the modifications, the same constituent elements as those in the embodiments described above are given the same reference numerals, and the following mainly describes the differences.

### Protection Element (Second Embodiment)

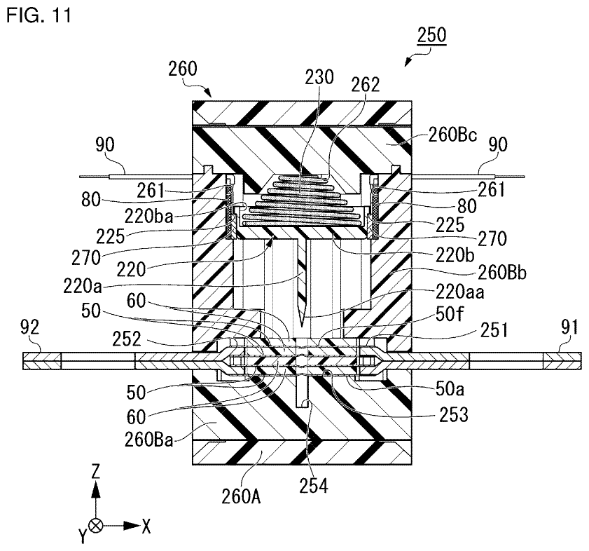

A protection element 250 according to a second embodiment of the present invention will be described with reference to FIG. 11 to FIG. 14. The protection element 250 of the second embodiment differs from that of the first embodiment described above mainly in the configurations including the arrangement of a locking member 270 and the heating element 80, and the like. In each drawing of the present embodiment, components that are similar or substantially similar to those in the first embodiment are denoted by the same reference numerals or names, or the like, and descriptions thereof may be omitted.

FIG. 11 is a cross-sectional view illustrating a protection element 250 of the present embodiment, specifically, a cross-sectional view illustrating the protection element 250 as a cross-section (X-Z cross-section) perpendicular to the width direction (Y direction).

The protection element 250 has an insulating case 260, a fuse element 50, a first terminal 91, a second terminal 92, an insulating member 60, a shielding member 220, a pressing means 230, a heating element 80, a locking member 270, and a power supply member 90.

### (Insulating Case)

The insulating case 260 has at least two (three in the present embodiment) holding members 260Ba, 260Bb, and 260Bc stacked in the vertical direction (Z direction), and a cylindrical cover 260A that houses these holding members 260Ba, 260Bb, and 260Bc. The cover 260A is fitted onto the outside of a plurality of holding members 260Ba, 260Bb, and 260Bc.

At least two holding members 260Ba, 260Bb are located on both sides of the fuse element 50 in the vertical direction. Specifically, of the three holding members 260Ba, 260Bb, and 260Bc, the first holding member 260Ba, which is located at the bottom, is located below the fuse element 50. Of the three holding members 260Ba, 260Bb, and 260Bc, the second holding member 260Bb is disposed above the fuse element 50. Of the three holding members 260Ba, 260Bb, and 260Bc, the third holding member 260Bc is disposed at the topmost position.

The first holding member 260Ba has an inner bottom surface 253 that is disposed on the upper surface of the bottom wall thereof and faces upward. That is, the insulating case 260 has an inner bottom surface 253. The inner bottom surface 253 has a groove 254 that extends along the opening or separation of the insulating member 60. The groove 254 extends along the width direction (Y direction) and opens upward.

The second holding member 260Bb has a heating element housing recess portion 261. The heating element housing recess portion 261 is disposed on the inner surface of the side wall of the second holding member 260Bb that faces inward (toward the center) in the current flow direction (X direction). Specifically, the heating element housing recess portion 261 is located at the upper end of the inner surface of the side wall of the second holding member 260Bb. The heating element housing recess portion 261 is recessed outward in the current flow direction from a portion of the inner surface of the side wall of the second holding member 260Bb that is adjacent to the lower side of the heating element housing recess portion 261.

The arrangement of the heating element housing recess portion 261 is not limited to the inner surface facing inward (toward the center) in the current flow direction (X direction), and may be disposed, for example, on the inner surface of the side wall of the second holding member 260Bb facing inward (toward the center) in the width direction (Y direction) orthogonal to the current flow direction (X direction).

A pair of heating element housing recesses 261 is provided on the inner surface of the side wall of the second holding member 260Bb, facing each other in the current flow direction. That is, a pair of heating element housing recesses 261 are disposed on the inner surface of the side wall of the second holding member 260Bb, at the end on the first terminal 91 side (+X side) in the current flow direction and the end on the second terminal 92 side (−X side).

The number of the heating element housing recesses 261 is not limited to one pair, and one may be disposed on either side.

FIG. 13 is a cross-sectional view that diagrammatically illustrates a portion of the protection element 250 of FIG. 11, specifically illustrating a cross-section perpendicular to the width direction (X-Z cross-section). As illustrated in FIG. 13, the second holding member 260Bb (that is, the insulating case 260) has a second step portion 263. The second step portion 263 is disposed at the lower end of the heating element housing recess portion 261 and faces upward. The second step portions 263 are provided in the pair of heating element housing recesses 261, respectively (that is, a pair). When one heating element housing recess portion 261 is disposed on one side, one second step portion 263 is provided in the heating element housing recess portion 261.

As illustrated in FIG. 11, the third holding member 260Bc has a pressing means housing recess portion 262. The pressing means housing recess portion 262 is disposed on the lower surface of the top wall of the third holding member 260Bc and is recessed upward.

FIG. 11 illustrates a case in which the pressing means 230 are a conical spring whose upper diameter is smaller than its lower diameter, but when the upper diameter of the conical spring is wider than the lower diameter or when it is a cylindrical spring, the pressing means housing recess portion 262 need not be present.

The insulating case 260 houses the fuse element 50, a portion of the first terminal 91, a portion of the second terminal 92, the insulating member 60, the shielding member 220, the pressing means 230, the heating element 80, the locking member 270, and the power supply member 90.

### (Fuse Element)

A plurality of fuse elements 50 is provided side by side in the vertical direction (thickness direction). In the present embodiment, four fuse elements 50 are disposed in parallel in the vertical direction. Insulating members 60 are disposed between adjacent fuse elements 50 in the vertical direction and on the upper side (outside) of the uppermost fuse element 50 (50f).

Furthermore, the inner bottom surface 253 of the first holding member 260Ba is disposed in close proximity to or in contact with the lower side (outside) of the lowermost fuse element 50 (50a). That is, the inner bottom surface 253 is disposed in proximity to or in contact with the side of the fuse element 50 opposite the shielding member 220 (that is, the lower side). More specifically, the inner bottom surface 253 is disposed in close proximity to or in contact with the outside of the outermost layer (fuse element 50a) of the multiple fuse elements 50 on the side opposite the shielding member 220.

The fuse element 50 is plate-shaped, extending in the current flow direction A pair of surfaces (front surface and back surface) of the fuse element 50 face each other in the vertical direction. The vertical direction is a direction perpendicular to the surface of the fuse element 50, and may therefore be rephrased as the parpendicular direction. A plurality of fuse elements 50 is stacked in parallel in the parpendicular direction.

The fuse element 50 has a first end 251 and a second end 252 opposed to each other. In other words, the fuse element 50 has a first end 251 and a second end 252 disposed at both ends in the current flow direction.

### (First Terminal, Second Terminal)

One end of the first terminal 91 is connected to the first end 251 and the other end is exposed to the outside from the insulating case 260. Specifically, the other end of the first terminal 91 protrudes from the insulating case 260 towards the first terminal 91 side (+X side) in the current flow direction.

The second terminal 92 is connected to the second end 252 at one end and exposed to the outside from the insulating case 260 at the other end. Specifically, the other end of the second terminal 92 protrudes from the insulating case 260 to the second terminal 92 side (−X side) in the current flow direction.

### (Insulating Material)

A plurality of insulating members 60 is provided side by side in the vertical direction. In the present embodiment, four insulating members 60 are disposed in parallel in the vertical direction. Each insulating member 60 is disposed adjacent to or in contact with each fuse element 50. The insulating member 60 has an opening or separation portion formed therein that extends in the width direction (Y direction).

A plurality of insulating members 60 is disposed between and outside the plurality of fuse elements 50 in contact with or in close proximity thereto. Specifically, the multiple insulating members 60 include an insulating member 60 disposed on the outer side (upper side) of the outermost layer (fuse element 50f) of the multiple fuse elements 50 on the shielding member 220 side (that is, the upper side).

However, this is not limited to the above, and although not specifically illustrated, the insulating member 60 located at the top may be formed integrally with the second holding member 260Bb and may constitute a portion of the second holding member 260Bb. In this case, the plurality of insulating members 60 are disposed in contact or proximity between the plurality of fuse elements 50.

The openings or separation portions of each of the insulating members 60 overlap one another when viewed in the parpendicular direction.

### (Shielding Member)

The shielding member 220 is disposed above the fuse element 50. When restriction on downward movement by the locking member 270 described later is released, the shielding member 220 can move downward while being inserted into the opening or separation portion of the insulating member 60 so as to cut off the fuse element 50 due to the pressing force (which can also be called stress or biasing force) of the pressing means 230.

Note that the vertical direction in which the shielding member 220 moves is also the direction in which the shielding member 220 is inserted into the opening or separation portion of the insulating member 60, and may therefore be referred to as the insertion direction. That is, the shielding member 220 is movable in the insertion direction.

The shielding member 220 has a convex portion 220a and a pressing means support portion 220b.

The convex portion 220a is plate-shaped, extending in a plane (Y-Z plane) perpendicular to the current flow direction (X direction). The upper end of the convex portion 220a is connected to the pressing means support portion 220b. The pressing means support portion 220b is generally plate-shaped and extends in a plane (X-Y plane) perpendicular to the vertical direction (Z direction).

The convex portion 220a protrudes downward from the pressing means support portion 220b. More specifically, the convex portion 220a protrudes toward the opening or separation portion of the insulating member 60 and the fuse element 50 in the insertion direction.

The convex portion 220a has a tip 220aa that is disposed at the lower end of the convex portion 220a and extends in the width direction (Y direction). The tip 220aa may also be referred to as the blade portion 220aa. In a cross-section perpendicular to the width direction (X-Z cross section), the tip 220aa has a V shape that is convex downward.

The pressing means support portion 220b has a recess portion 220ba and a first step portion 225. That is, the shielding member 220 has a first step portion 225. The recess portion 220ba is recessed downward from the upper surface of the pressing means support portion 220b.

As illustrated in FIG. 13, the first step portion 225 protrudes from the outer surface of the pressing means support portion 220b. Specifically, in the present embodiment, the first step portions 225 are provided on the outer surface of the pressing means support portion 220b at portions facing outward on both sides (that is, a pair) in the current flow direction (X direction).

The first step portion 225 faces the insertion direction of the shielding member 220, and specifically, faces downward. In the insertion direction (vertical direction), the first step portion 225 and the second step portion 263 face in opposite directions to each other. When viewed from the insertion direction, the first step portion 225 and the second step portion 263 do not overlap with each other.

### (Pressing Means)

As illustrated in FIG. 11, the pressing means 230 are disposed above the shielding member 220. Specifically, the pressing means 230 are disposed between the upper surface of the pressing means support portion 220b and the lower surface of the third holding member 260Bc. The pressing means 230 are a spring (biasing member) such as an elastically deformable compression coil spring, and in the present embodiment, has a generally conical shape that expands in diameter as it extends downward.

The lower portion of the pressing means 230 is disposed (housed) in a recess portion 220ba provided in the upper surface of the pressing means support part 220b. The upper portion of the pressure means 230 is disposed (housed) in the pressure means housing recess portion 262 provided on the lower surface of the third holding member 260Bc.

The pressing means 230 press the shielding member 220 in the insertion direction of the shielding member 220 (downward). Specifically, the pressing means 230 are assembled into the protection element 250 in a state in which it is elastically deformed by contracting in the vertical direction, and presses the pressing means support portion 220b downward by a pressing force (stress, biasing force) due to a restoring deformation force.

### (Heating Element, Power Supply Member)

As illustrated in FIG. 11 and FIG. 13, the heating element 80 is plate-shaped, and a pair of surfaces (front surface and rear surface) thereof face the current flow direction (X direction). The heating element 80 is placed (housed) in the heating element housing recess portion 261. The heating elements 80 are provided in the pair of heating element housing recesses 261, respectively (that is, a pair). In the present embodiment, the heating element 80 heats and softens the locking member 270.

When the heating element housing recess portion 261 is positioned on the inner surface of the side wall of the second holding member 260Bb facing inward (toward the center) in the width direction (Y direction) orthogonal to the current flow direction (X direction), the heating element 80 is positioned in an orientation that matches the heating element housing recess portion 261. That is, in this case, a pair of surfaces of the heating element 80 face the width direction (Y direction).

When one heating element housing recess portion 261 is located on one side, one heating element 80 is provided in the heating element housing recess portion 261.

The power supply member 90 supplies electric current to the heating element 80.

### (Locking Member)

The locking member 270 of the present embodiment is formed, for example, such as by Ag plating a square plate-shaped solder material. The locking member 270 is disposed adjacent to the heating element 80. The locking member 270 and the heating element 80 are disposed facing each other, and in the present embodiment, the direction in which these members face each other is the current flow direction (X direction). A pair of surfaces (front surface and rear surface) of the locking member 270 face the current flow direction (X direction). When viewed in the width direction (Y direction), the dimension L2 in the insertion direction (Z direction) of the locking member 270 is larger than the dimension L1 in the current flow direction of the locking member 270 (the dimension in the direction from the heating element 80 toward the locking member 270). Although not specifically illustrated, in the present embodiment, the dimension of the locking member 270 in the width direction (Y direction) is greater than the dimensions L1 and L2. That is, the locking member 270 has a rectangular plate shape with the width direction as the longitudinal direction.

When the heating element housing recess portion 261 is located on the inner surface of the side wall of the second holding member 260Bb that faces inward (toward the center) in the width direction (Y direction) orthogonal to the current flow direction (X direction), the locking member 270 is oriented to match the heating element housing recess portion 261. That is, in this case, a pair of surfaces of the locking member 270 face the width direction (Y direction), and the direction in which the locking member 270 and the heating element 80 face each other is the width direction (Y direction). In this case, the dimension L2 in the insertion direction (Z direction) of the locking member 270 is larger than the dimension L1 in the width direction (Y direction) of the locking member 270 (in the direction from the heating element 80 to the locking member 270) when viewed from the current flow direction (X direction).

A pair of locking members 270 is provided, disposed adjacent to a pair of heating elements 80. One of the pair of surfaces (front surface and rear surface) of each locking member 270 is disposed adjacent to or in contact with the heating element 80. The other of the pair of faces of the locking member 270 is disposed in close proximity to or in contact with the outer surface of the pressing means support portion 220b of the shielding member 220.

When one heating element housing recess portion 261 is disposed on one side, the locking member 270 is disposed so as to be adjacent to one heating element 80.

Furthermore, a pair of end surfaces of the locking member 270 facing the insertion direction (vertical direction) is sandwiched between the first step portion 225 and the second step portion 263. That is, the locking member 270 is supported by being sandwiched between the pressing means support portion 220b of the shielding member 220 and the second holding member 260Bb of the insulating case 260 in the insertion direction. In this manner, the locking member 270 is sandwiched and locked between the insulating case 260 and the shielding member 220 in the insertion direction of the shielding member 220. That is, the locking member 270 is locked between the insulating case 260 and the shielding member 220, and prevents the shielding member 220 from moving.

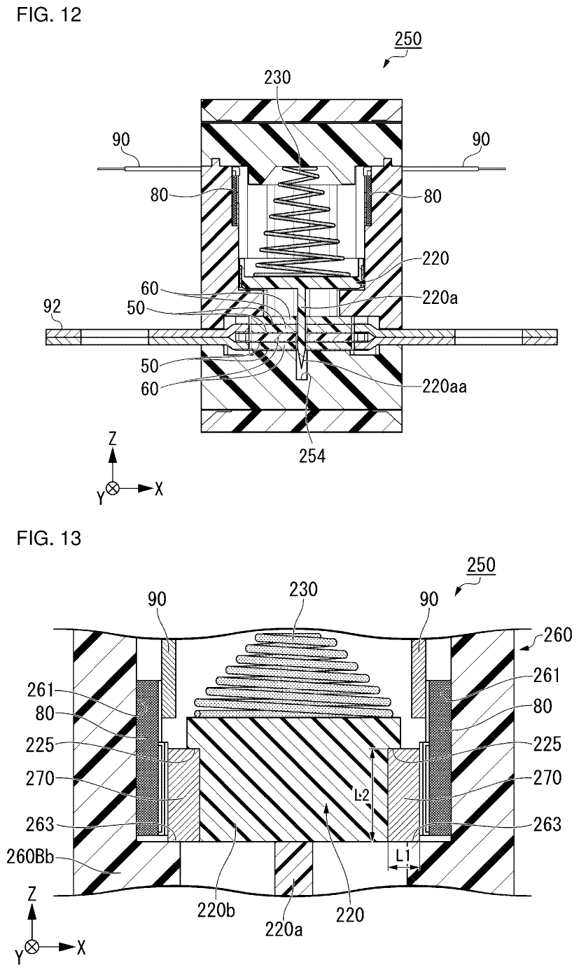

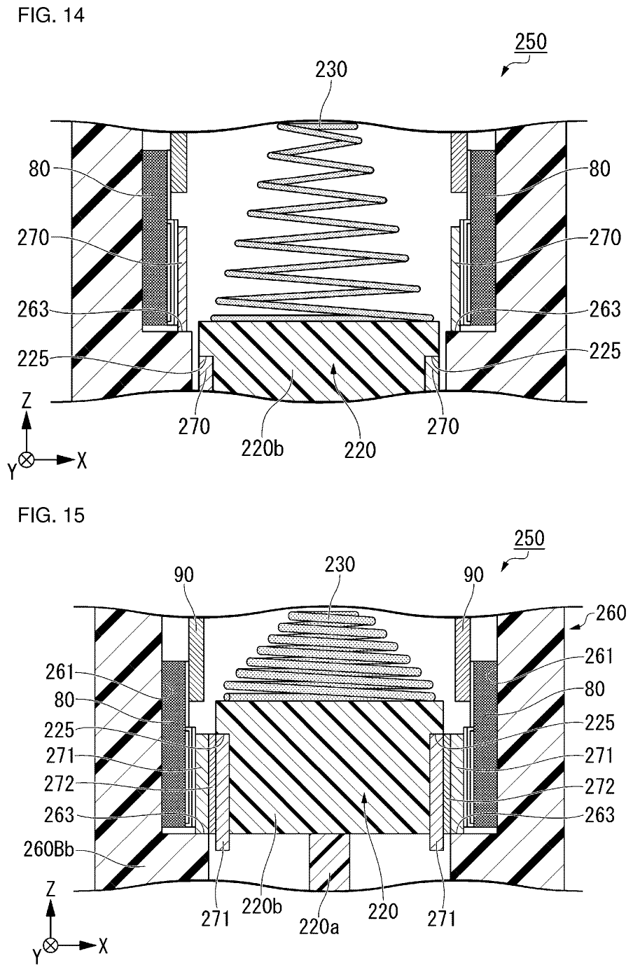

FIG. 12 and FIG. 14 are cross-sectional views (X-Z cross-sectional views) illustrating the protection element 250 or a portion of it, illustrating a state in which the shielding member 220 has moved downward in the insertion direction.

When power is supplied from the power supply member 90 to the heating element 80, the heating element 80 generates heat. When the heating element 80 generates heat, the heat causes the locking member 270 to soften. Due to the locking member 270 softening, the pressing force of the pressing means 230 causes the shielding member 220 to move while separating the locking member 270. Specifically, for example, as illustrated in FIG. 14, the softened locking member 270 is separated into the heating element 80 side and the shielding member 220 side. This allows the shielding member 220 to move downward.

When restriction on the downward movement of the shielding member 220 by the locking member 270 is released, the shielding member 220 moves downward due to the pressing force of the pressing means 230. The shielding member 220 moves through the opening or separation portion of the insulating member 60 to cut the fuse element 50, thereby interrupting the flow of electricity through the fuse element 50. Furthermore, the shielding member 220 cuts the fuse element 50, and shields each portion of the cut fuse element 50 from each other in the current flow direction of the fuse element 50.

In the present embodiment, as illustrated in FIG. 12, the shielding member 220 moves downward, so that the tip 220aa of the convex portion 220a is placed in the groove 254. That is, the tip 220aa of the shielding member 220 in the insertion direction can be inserted into the groove 254. The shielding member 220 is movable within all of the openings or separations of the insulating member 60, and furthermore, in the present embodiment, is movable within the groove 254.

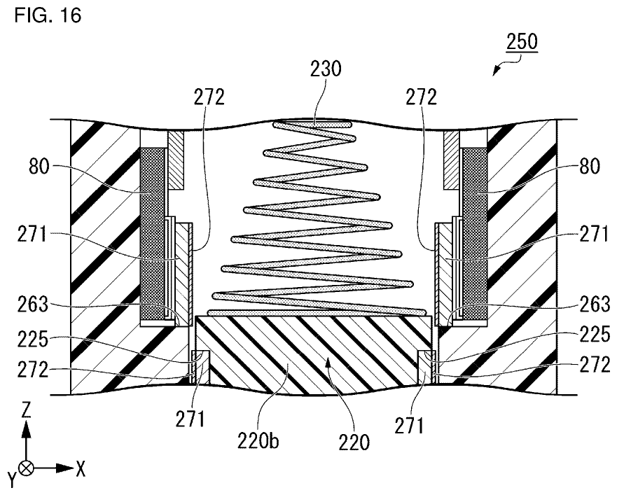

Here, FIG. 15 and FIG. 16 are cross-sectional views (X-Z cross-sectional views) illustrating a portion of a protection element 250 according to a modification of the present embodiment. In this modification, instead of the aforementioned locking member 270, a pair of locking members 271 made of, for example, copper plate or the like, and a fixing member 272 made of, for example, solder or the like, are used which are disposed between the pair of locking members 271 and fix these locking members 271. In this modification, the heating element 80 heats and softens the fixed member 272.

Due to the fixing member 272 softening, the pressing force of the pressing means 230 causes the shielding member 220 to move while separating the fixing member 272. Specifically, for example, as illustrated in FIG. 16, the softened fixing member 272 is separated into one locking member 271 side and the other locking member 271 side of the pair of locking members 271 that sandwich the fixing member 272. This allows the shielding member 220 to move downward.

In the protection element 250 of the present embodiment, when an overcurrent exceeding the rated current flows through the fuse element 50, the fuse element 50 is thermally melted to interrupt the current path.in addition, it is possible to pass a current through the heating element 80 to soften the locking member 270 or fixing member 272 that suppresses the movement of the shielding member 220, and move the shielding member 220 by the pressing force of the pressing means 230, thereby physically cutting the fuse element 50 and interrupting the current path.

In the present embodiment, the fuse element 50 and the insulating member 60 are in close proximity to or in contact with each other, and preferably in close contact with each other. This eliminates the space between the fuse element 50 and the insulating member 60 in which arcing can continue, ensuring that arcing is extinguished. In the present embodiment, the locking members 270 and 271 are not disposed near the fuse element 50, but are provided between the insulating case 260 and the shielding member 220, and are locked to these members to restrict downward movement of the shielding member 220.

Therefore, the locking members 270 and 271 can be disposed away from members such as the fuse element 50 and the insulating member 60, whose temperatures may rise when electricity is applied to the protection element 250 (during normal use). This prevents the functions of the locking members 270 and 271 from being affected by a rise in temperature of each member.

Furthermore, since the pressing force of the pressing means 230 are not transmitted to the fuse element 50 and the insulating member 60 via the locking members 270 and 271, the functions of the fuse element 50 and the insulating member 60 are maintained excellent for a long period of time.

In addition, the tip 220aa of the convex portion 220a of the shielding member 220 can be disposed closer to the fuse element 50 and the insulating member 60. This allows the outer dimensions of the insulating case 260 in the vertical direction (insertion direction, thickness direction) to be kept small, making it possible to reduce the size of the protection element 250.

### Effect of Present Embodiment

Similarly to the foregoing first embodiment, the fuse element 50 of the present embodiment described above has a first element 51 made of silver or copper, or an alloy mainly composed of silver or copper, a second element 52 made of silver or copper, or an alloy mainly composed of silver or copper, and connected in series to the first element 51 on the current path, a third element 53 made of silver or copper, or an alloy mainly composed of silver or copper, and connected in series with the first element 51 on the current path, a connecting metal 86 composed of tin or an alloy mainly composed of tin, connecting one end 51a of the first element 51 and one end of the second element 52, and a connecting metal 86 connecting another end 51b of the first element 51 and one end of the third element 53.

According to this configuration, when interrupting a relatively small overcurrent, such as 1.5 times the rated current, the combination of first element 51 (hereinafter also referred to as silver foil element 51) made of silver or an alloy mainly composed of silver and connecting metal 86 (hereinafter also referred to as tin connecting metal 86) made of tin or an alloy mainly composed of tin makes it possible for the fuse element to blow at about 300° C. As a result, even when the insulating case 10 is a plastic case with a melting point of approximately 300° C., damage to the case can be suppressed. Furthermore, by using the thin silver foil element 51 as the blowing portion, the amount of molten material scattered when a high voltage and large current is interrupted can be reduced. This makes it possible to reduce the scale of arc discharge and to improve the insulation resistance. In addition, in the spring interruption method, by using a soft and thin silver foil element 51 with a Vickers hardness of about 25HV in the interruption portion, the spring stress at the time of cutting can be reduced. In addition, in the heater blowing method, the combination of the silver foil element 51 and the connecting metal 86 composed of tin enables the fuse element 50 to blow at about 300° C. Therefore, it is possible to provide a fuse element 50 that melts at a low temperature of about 300° C., has a low molten volume, and is easy to cut.

Furthermore, the silver foil element 51 has better compatibility with solder than copper, and the silver foil melts when the solder melts, thereby interrupting the current flow through the fuse element 50. Furthermore, the silver foil is thin (has a small volume), and thus deterioration of the insulation resistance due to sublimation during interruption of an overcurrent can be suppressed.

Furthermore, as a result of careful investigation, the present inventors have come to the conclusion that similar effects can be obtained when the first element 51 is composed of copper foil, as in the second element 52 and the third element 53 (that is, it is possible to provide a fuse element that melts at a low temperature of about 300° C., has a small molten volume, and is easy to cut). That is, the same effects as those of the silver foil element 51 can be obtained by combining the first element 51 (copper foil element 51) composed of copper or an alloy mainly composed of copper with the connecting metal 86 composed of tin.

Furthermore, In the protection element 250 of the present embodiment, due to being provided with the fuse element 50, it is possible to provide a protection element 250 that combines overcurrent shutdown and active shutdown.

Furthermore, according to the present embodiment, a large-scale arc discharge is unlikely to occur when the fuse element 50 melts, and it is possible to reduce the size and weight of the insulating case 260, while it is possible to provide a protection element 250 that combines an overcurrent interrupt function compatible with high voltages and large currents, and a interrupt function based on an interrupt signal.

In the present embodiment, the heat generated by the heating element 80 softens the locking member 270 or the fixing member 272, and the pressing force of the pressing means 230 causes the shielding member 220 to move downward while separating the locking member 270 or the fixing member 272. Restriction on the downward movement of the shielding member 220 is stably released, and thus the current flow through the fuse element 50 can be more reliably cut off.

In the present embodiment, when the shielding member 220 moves downward, the tip 220aa of the convex portion 220a is inserted into the groove 254 in the inner bottom surface 253 of the insulating case 260. This allows the fuse element 50 that is in close proximity to or in contact with the inner bottom surface 253 to be reliably cut by the shielding member 220.

In the present embodiment, the dimension L2 in the insertion direction of the locking member 270 is larger than the dimension L1 in the current flow direction of the locking member 270 (the direction from the heating element 80 to the locking member 270), viewed from the width direction (Y direction). Alternatively, viewed from the current flow direction (X direction), the dimension L2 in the insertion direction of the locking member 270 is larger than the dimension L1 in the width direction of the locking member 270 (the direction from the heating element 80 to the locking member 270).

According to the above configuration, the shear force in the insertion direction of locking member 270 is increased, so that locking member 270 can be stably held (locked) between insulating case 260 and shielding member 220.

Furthermore, in the present embodiment, a pair of end surfaces facing the insertion direction of locking members 270 and 271 are sandwiched between first step portion 225 and second step portion 263, and when viewed from the insertion direction, first step portion 225 and second step portion 263 do not overlap with each other.

According to the above configuration, when the fixing member 272 fixing the locking member 270 or the locking member 271 softens and the shielding member 220 moves downward due to the pressing force of the pressing means 230, the first step portion 225 and the second step portion 263 which held the locking members 270 and 271 reliably pass each other in the insertion direction. Therefore, the downward movement of the shielding member 220 is not hindered by the first step portion 225 and the second step portion 263, and the current of the fuse element 50 is reliably interrupted.

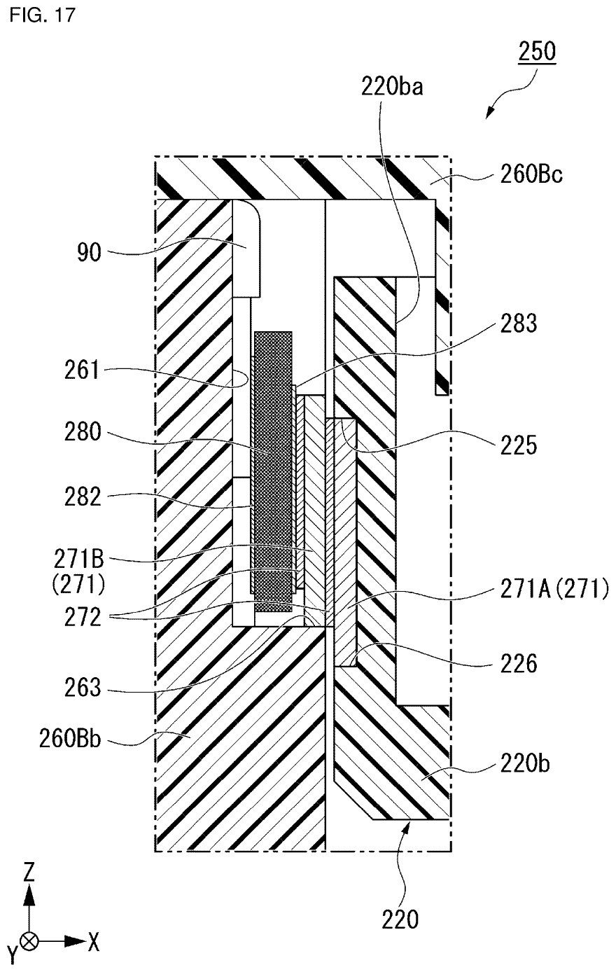

Next, the protection element 250 according to another modification of the present embodiment will be described with reference to FIG. 17 to FIG. 21. As illustrated in FIG. 17, in this modification, the pressing means support portion 220b has a third step portion 226 in addition to the recess portion 220ba and the first step portion 225 described above. That is, the shielding member 220 has a first step portion 225 and a third step portion 226.

As illustrated in FIG. 17, the third step portion 226 is disposed below the first step portion 225. The third step portion 226 protrudes from the outer surface of the pressing means support portion 220b. Specifically, in the present embodiment, the third step portion 226 is provided on each (that is, a pair) of the outer faces of the pressure means support 220b that face both sides of the current flow direction (X direction). In addition, in FIG. 17, the portion facing outward in the −X direction is illustrated.

The third step portion 226 faces the insertion direction of the shielding member 220, specifically upward. In the insertion direction (vertical direction), the third step portion 226 and the first step portion 225 face opposite side of each other. In the insertion direction (vertical direction), the third step portion 226 and the second step portion 263 face the same side of each other. When viewed from the insertion direction, the third step portion 226 and the second step portion 263 do not overlap with each other. Viewed from the insertion direction, the third step portion 226 and the first step portion 225 overlap each other.

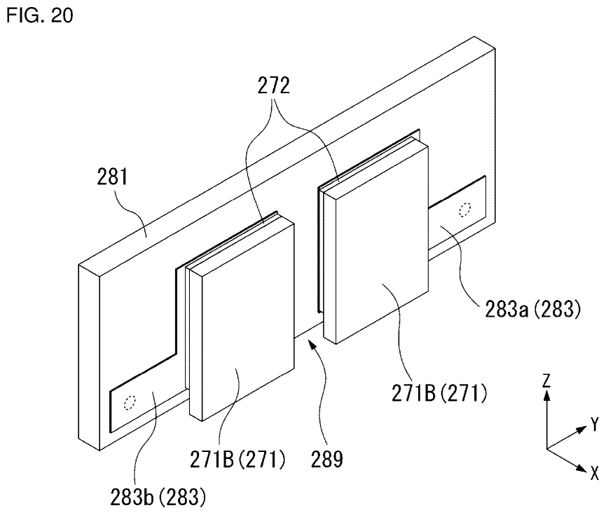

Furthermore, in this modification, one of the pair of locking members 271 described above is split. In this modification, of the pair of locking members 271, the undivided locking member 271 may be referred to as a “first locking member 271A,” and the divided locking member 271 may be referred to as a “second locking member 271B.” As illustrated in FIG. 19 and FIG. 20, in this modification, a pair of second locking members 271B is provided spaced apart from each other in the width direction (Y direction). In this modification, fixing member 272 is made of, for example, solder or the like, and is disposed between a pair of locking members 271 (specifically, between first locking member 271A and second locking member 271B) to fix these locking members 271. In this modification, the heating element 280 heats and softens the fixed member 272.

Due to the fixing member 272 softening, the pressing force of the pressing means 230 causes the shielding member 220 to move while separating the fixing member 272. Specifically, as illustrated in FIG. 16, for example, the softened fixing member 272 is separated from the pair of locking members 271 that sandwich the fixing member 272 into one locking member 271 side (first locking member 271A side) and the other locking member 271 side (second locking member 271B side). This allows the shielding member 220 to move downward.

The heating element 280 is plate-shaped, a pair of faces (front and back) thereof facing the current flow direction (X direction). In this modification, one of a pair of surfaces (front surface and rear surface) of an insulating substrate 281 (heating element 280) is formed with a pair of third electrode portions 285 for connecting a power supply member 90 and a pair of heating element electrodes 286.

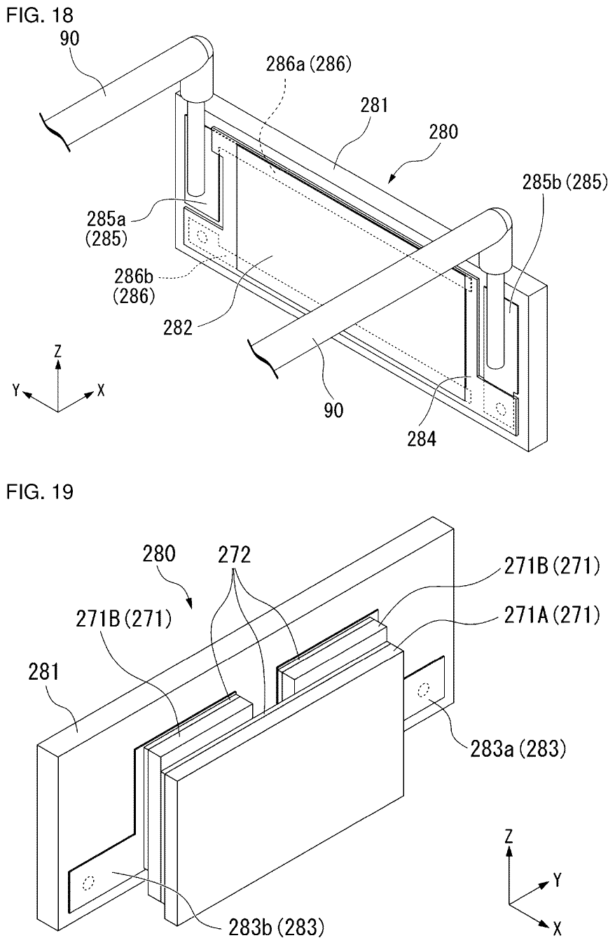

As illustrated in FIG. 18 and FIG. 19, the heating element 280 has an insulating substrate (substrate) 281, a resistive layer 282 laminated on the insulating substrate 281, a metal layer 283 laminated on the insulating substrate 281 and facing the shielding member 220 in the front-to-rear direction, an insulating layer 284, a pair of third electrode portions 285, and a pair of heating element electrodes 286. In this modification, the heating element 280 is long in the left-right direction (Y-axis direction), and the insulating substrate 281, the resistive layer 282, and the insulating layer 284 are also long in the left-right direction.

Specifically, as illustrated as an example in FIG. 18 and FIG. 19, the heating element 280 has a resistive layer 282 on one of a pair of surfaces (front surface and rear surface) of an insulating substrate 281 (in this modification, the surface facing the inner surface of the side wall of the second holding member 260Bb), an insulating layer 284 covering this resistive layer 282, a pair of heating element electrodes 286 formed on the one surface of the insulating substrate 281 and electrically connected to the resistive layer 282, a pair of third electrode portions 285, and a metal layer 283 disposed on the other of the pair of surfaces (front surface and rear surface) of the insulating substrate 281 (in this modification, the surface facing the shielding member 220).

In this modification, a pair of heating element electrodes 286 has a first heating element electrode 286a that is long in the left-right direction and connected to the upper a portion of the resistive layer 282, and a second heating element electrode 286b that is long in the left-right direction and connected to the lower a portion of the resistive layer 282.

The third electrode 285 is located on one side of the insulating substrate 281 at edges in the left-right direction. The third electrode portions 285 are provided in a pair spaced apart from each other in the left-right direction. At least a portion of the third electrode 285 is exposed outside the heating element 280 without being covered by the insulation layer 284.

The metal layer 283 is disposed on the other of the pair of surfaces (front surface and rear surface) of insulating substrate 281 (in this modification, the surface facing shielding member 220). In this modification, the metal layer has a first metal portion 283a that is long in the left-right direction, and a second metal portion 283b that is spaced apart from the first metal portion 283a and is long in the left-right direction. The first metal portion 283a is electrically connected to one (285a) of the pair of third electrode portions 285 via a through hole. The second metal portion 283b is electrically connected to the other (285b) of the pair of third electrode portions 285 via a through-hole.

In this modification, one of the pair of second locking members 271B is fixed to first metal portion 283a with fixing member 272 such as solder. The other of the pair of second locking members 271B is fixed to the second metal part 283b with a fixing member 272 such as solder.

The resistive layer 282 is a member having conductivity that generates heat when energized at a relatively high resistance, and is made of, for example, nichrome, W, Mo, Ru, or the like, or a material containing these. The resistive layer 282 may be formed by mixing a powder of an alloy, composition, or compound of these with a resin binder or the like to form a paste, forming a pattern on the insulating substrate 281 using a screen printing technique, and then firing, or the like.

The insulating substrate 281 is an insulating substrate such as alumina, glass ceramic, mullite, or zirconia. The insulating layer 284 is provided to protect the resistive layer 282. For example, insulating materials such as ceramics and glass can be used for the insulating layer 284. The insulating layer 284 may be formed, for example, by method for coating and firing a glass-based paste, or the like.

The heating element 280 is energized and heated by a current control element in the external circuit when it is necessary to interrupt the current path, such as due to an abnormality in the external circuit that serves as the current path for the protection element 250.

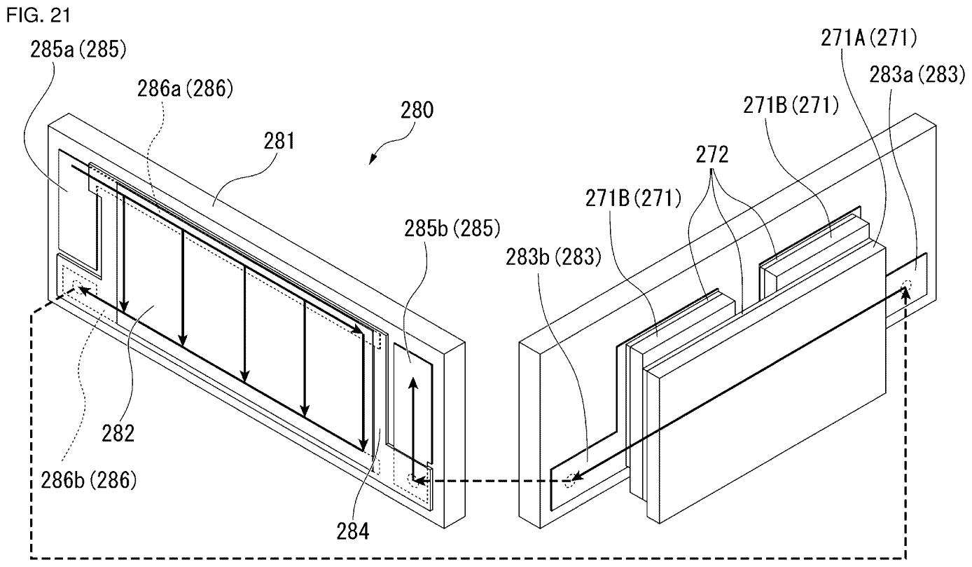

As illustrated in FIG. 21, in this modification, a first locking member 271A forms a portion of a current path in a heating element 280. For example, a current flows along a current path in the direction of an arrow illustrated in FIG. 12. In this modification, the first locking member 271A moves downward together with the shielding member 220, thereby interrupting the current path. This allows the power supply to be automatically stopped. In FIG. 20, reference numeral 289 indicates a current-stopping portion 289 formed between the pair of second locking members 271B.

In this modification, the first locking member 271A is disposed on the third step portion 226. Therefore, when the current path is interrupted, the first locking member 271A can be prevented from falling off.

An adhesive layer may be provided on the surface of first locking member 271A opposite to second locking member 271B (the surface facing the shielding member).

### Modifications

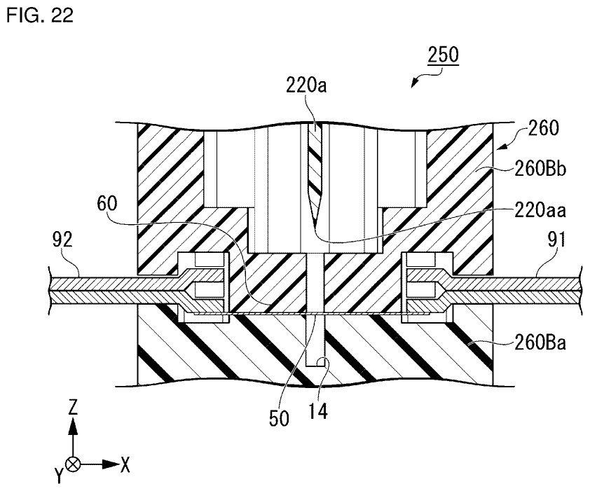

FIG. 22 is a cross-sectional view (X-Z cross-sectional view) illustrating a portion of a protection element 250 according to another modification of the present embodiment. In this modification, one or both of the two holding members 260Ba, 260Bb of the insulating case 260 are formed integrally with the insulating member 60. In the illustrated example, one of the two holding members 260Ba and 260Bb (holding member 260Bb) is formed integrally with the insulating member 60. Moreover, only a single layer (one) of fuse element 50 is provided.

In the above configuration, the insulating member 60 is integrated with the holding members 260Ba and 260Bb. This makes it possible to reduce the number of parts, facilitate the manufacture of the protection element 250, and reduce the manufacturing costs.

The protection element of the present invention is not limited to the embodiments described above.

The present invention may be implemented by combining the various configurations described in the foregoing embodiments, modifications, and reference examples, and the like, without departing from the spirit of the present invention, and addition, omission, substitution, and other modifications of the configurations are possible. Furthermore, the present invention is not limited to the embodiments and the like described above, but is limited only by the Scope of Patent Claims.

### DESCRIPTION OF REFERENCE NUMERALS

50 Fuse element
51 First element
51a First end (one end of the first element)
51b Second end (other end of first element)
52 Second Element
53 Third element
80 Heating element
86 Connecting metal
91 First terminal
92 Second terminal
100 Protection element
Z1 Thickness of the first element
Z2 Thickness of the second element
Z3 Thickness of the third element

1: A fuse element, comprising:
a first element made of silver or copper, or an alloy comprising silver or copper as a main component thereof;
a second element made of silver or copper, or an alloy comprising silver or copper as a main component thereof; and
a connecting metal composed of tin or an alloy comprising tin as a main component thereof, connecting an end of the first element to an end of the second element.

2: The fuse element according to claim 1, wherein
heat generated by an overcurrent flowing through the fuse element melts the connecting metal, and a molten material of the connecting metal melts the end of the first element, thereby blowing at least the first element.

3: The fuse element according to claim 1, wherein
a thickness of the first element is thinner than a thickness of the second element.

4: The fuse element according to claim 3, wherein
the thickness of the first element is half or less of the thickness of the second element.

5: A protection element, comprising:
a first terminal;
a second terminal; and
a fuse element connected to a current path connecting the first terminal and the second terminal,
the fuse element comprising:
a first element made of silver or copper, or an alloy comprising silver or copper as a main component thereof;
a second element made of silver or copper, or an alloy comprising silver or copper, as a main component thereof, and connected in series to the first element on the current path; and
a connecting metal composed of tin or an alloy comprising tin as a main component thereof, connecting an end of the first element and an end of the second element.

6: The protection element according to claim 5, wherein
heat generated by an overcurrent flowing through the fuse element melts the connecting metal, and a molten material of the connecting metal melts the end of the first element, thereby blowing at least the first element.

7: The protection element according to claim 5, wherein
the thickness of the first element is thinner than the thickness of the second element.

8: The protection element according to claim 7, wherein
the thickness of the first element is half or less of the thickness of the second element.

9: The protection element according to claim 5, further comprising
a heating element, wherein
the heating element generates heat to melt the connecting metal, and the molten material of the connecting metal melts the end of the first element, thereby blowing at least the first element.

10: The protection element according to claim 5, wherein
the protection element comprises a plurality of the fuse elements, and
the plurality of the fuse elements are connected in parallel between the first terminal and the second terminal.

11: A protection element, comprising:
a first terminal;
a second terminal;
a fuse element connected to a current path connecting the first terminal and the second terminal,
the fuse element comprising:
a first element made of silver or copper, or an alloy comprising silver or copper as a main component thereof;
a second element made of silver or copper, or an alloy comprising silver or copper as a main component thereof, and connected in series to the first element on the current path;
a third element made of silver or copper, or an alloy comprising silver or copper as a main component thereof, and connected in series with the first element on the current path;
a connecting metal composed of tin or an alloy comprising tin as a main component thereof, connecting one end of the first element and one end of the second element, and connecting other end of the first element and one end of the third element.

12: The protection element according to claim 11, wherein
heat generated by an overcurrent flowing through the fuse element melts the connecting metal, and a molten material of the connecting metal melts the one or the other end of the first element, thereby blowing at least the first element.

13: The protection element according to claim 11, wherein
a thickness of the first element is thinner than each of a thickness of the second element and a thickness of the third element.

14: The protection element according to claim 13, wherein
the thickness of the first element is half or less of each of the thickness of the second element and the thickness of the third element.

15: The protection element according to claim 11, further comprising
a heating element, wherein
the heating element generates heat to melt the connecting metal, and the molten material of the connecting metal melts the one end or the other end of the first element, thereby blowing at least the first element.

16: The protection element according to claim 11, wherein
the protection element comprises a plurality of the fuse elements, and
the plurality of the fuse elements are connected in parallel between the first terminal and the second terminal.
